(19) United States
(12) Patent Application Publication
(10) Pub. No.: US 2017/0317938 A1
(43) Pub. Date: Nov. 2, 2017

(54) DETERMINATION OF A DATA TRANSMISSION SCHEDULE

(71) Applicant: QUALCOMM Incorporated, San Diego, CA (US)

(72) Inventors: Santosh Paul ABRAHAM, San Diego, CA (US); Abhishek Pramod PATIL, San Diego, CA (US); George CHERIAN, San Diego, CA (US); Alireza RAISSINIA, Monte Sereno, CA (US); Abhijeet BISAIN, San Diego, CA (US); Xiaolong LI, San Diego, CA (US); Ajay VUNDYALA, Jersey City, NJ (US)

(21) Appl. No.: 15/482,605

(22) Filed: Apr. 7, 2017

Related U.S. Application Data
(60) Provisional application No. 62/330,748, filed on May 2, 2016.

(51) Int. Cl. H04L 12/851; H04L 12/931; H04L 9/34; H04L 29/08

(52) U.S. Cl. CPC H04L 47/24; H04L 67/322; H04L 67/108; H04L 9/34; H04L 29/08477; H04L 49/205

(57) ABSTRACT

A device for communication includes a processor and a transmitter. The processor is configured to determine a target quality of service (QoS). The processor is also configured to determine, based on the target QoS, a transmission schedule identifying one or more transmission time-blocks. The transmitter is configured to transmit data to at least one device during a transmission time-block of the one or more transmission time-blocks.

### I. CROSS-REFERENCE TO RELATED APPLICATIONS

The present application claims priority from U.S. Provisional Patent Application No. 62/330,748, filed May 2, 2016, entitled “DETERMINATION OF A DATA TRANSMISSION SCHEDULE,” which is incorporated by reference in its entirety.

### II. FIELD

The present disclosure is generally related to determining a data transmission schedule.

### III. DESCRIPTION OF RELATED ART

Advances in technology have resulted in smaller and more powerful computing devices. For example, there currently exists a variety of portable personal computing devices, including wireless telephones, such as mobile and smart phones, tablets and laptop computers that are small, lightweight, and easily carried by users. These devices can communicate voice and data packets over wireless networks. Further, many such devices incorporate additional functionality, such as a digital still camera, a digital video camera, a digital recorder, and an audio file player. Also, such devices can process executable instructions, including software applications, such as a web browser application, that can be used to access the Internet. As such, these devices can include significant computing capabilities.

Electronic devices, such as wireless telephones, may use wireless connections to access networks in order to transmit and receive data or to exchange information. For example, mobile electronic devices that are in close proximity to each other may form a wireless mesh network to perform data exchange via the wireless mesh network (e.g., without involving wireless carriers, Wi-Fi access points, or the Internet). To enable functionality of the wireless mesh network, a particular wireless channel may be reserved for transferring data between electronic devices of the wireless mesh network. For example, a “provider” device of the wireless mesh network may share a service, such as a music service, with other electronic devices in the wireless mesh network. To illustrate, the provider device may transmit music data to a subscriber device in the wireless mesh network. Because the subscriber device does not know when the provider device will transmit the music data, the subscriber device may substantially continuously monitor the wireless mesh network for transmissions from the provider device. Accordingly, the subscriber device consumes power to monitor the wireless mesh network, even during time periods when the provider device is not transmitting data to the subscriber device.

### IV. SUMMARY

In a particular aspect, a device for communication includes a processor and a transmitter. The processor is configured to determine a target quality of service (QoS). The processor is also configured to determine, based on the target QoS, a transmission schedule identifying one or more transmission time-blocks. The transmitter is configured to transmit data to at least one device during a transmission time-block of the one or more transmission time-blocks.

In another aspect, a method of communication includes determining, at a particular device, a target quality of service (QoS). The method also includes determining, based on the target QoS, a transmission schedule identifying one or more transmission time-blocks. The method further includes sending data, from the particular device to at least one device, during a transmission time-block of the one or more transmission time-blocks.

In another aspect, a computer-readable storage device stores instructions that, when executed by a processor, cause the processor to perform operations including determining a target quality of service (QoS). The operations also include determining, based on the target QoS, a transmission schedule identifying one or more transmission time-blocks. The operations further include sending data to at least one device during a transmission time-block of the one or more transmission time-blocks.

Other aspects and features of the present disclosure will become apparent after review of the entire application, including the following sections: Brief Description of the Drawings, Detailed Description, and the Claims.

### V. BRIEF DESCRIPTION OF THE DRAWINGS

FIG. 1 is a block diagram of a particular illustrative aspect of a system operable to determine a schedule of data transmission;

FIG. 2 is a diagram of another aspect of a system operable to determine a schedule of data transmission;

FIG. 3 is a diagram of a system operable to determine a schedule of data transmission;

FIG. 4 is a diagram of a system operable to determine a schedule of data transmission;

FIG. 5 is a diagram of a system operable to determine a schedule of data transmission;

FIG. 6 is a diagram of a system operable to determine a schedule of data transmission;

FIG. 7 is a diagram of timelines corresponding to operation of a system operable to determine a schedule of data transmission;

FIG. 8 is a diagram of a system operable to determine a schedule of data transmission;

FIG. 9 is a diagram illustrating various aspects of a neighbor aware network (NAN) data link (NDL) attribute;

FIG. 10 is a diagram illustrating various aspects of a dynamic channel selection (DCS) attribute;

FIG. 11 is a diagram of timelines corresponding to operation of a system operable to determine a schedule of data transmission;

FIG. 12 is a flowchart of a method of operation at an electronic device of one or more of the systems disclosed herein; and

FIG. 13 is a diagram of a device that is operable to support various aspects of one or more methods, systems, devices, apparatuses, and computer-readable media disclosed herein.

### VI. DETAILED DESCRIPTION

The present disclosure is directed to systems and methods of determining a schedule of data transmission. Electronic devices in a data link group of a neighbor aware network (alternatively referred to as neighbor awareness networking) (NAN) may use traffic advertisements to coordinate times to exchange traffic (e.g., data) of a particular service. As referred to herein, a “data link group” refers to one or more electronic devices that share a time period corresponding to an active operating mode of the electronic devices (e.g., a paging window) and that have shared security credentials. For example, a data link group may include or correspond to a wireless mesh network, such as a “social wireless fidelity (Wi-Fi) mesh (SWF-mesh)”. The one or more electronic devices of the data link group may be a subset of electronic devices in the NAN. As referred to herein, “data path link”, “data link (DL)”, “NAN Data Link (NDL)”, “data path (DP)”, “NAN DP (NDP)”, or “NAN DP group” may refer to the data link group. Devices participating in the data link group may be configured to synchronize based on beaconing operations of the NAN. For example, while within the NAN, devices may be configured to transmit or to receive synchronization beacons. The devices may be configured to synchronize respective internal clocks based on the synchronization beacons. Because the internal clocks of the devices may be synchronized, the devices of the data link group may determine a common time period to transition to an active operating mode and monitor a communication channel for a traffic advertisement. The common time period may correspond to a paging window. A device may transition to low-power mode until a subsequent paging window in response to determining that there is no incoming or outgoing traffic based on traffic advertisements.

Data exchanged via the data link group may be protected based on security credentials. A “data link identifier” may refer to an identifier indicating the data link group. As referred to herein, “NDL-group address” may refer to the data link identifier.

A first device may be configured to provide data corresponding to a service (e.g., an application) to one or more second devices. With regard to the service, the first device may correspond to a provider device and the one or more second devices may correspond to subscriber devices. Devices may exchange data corresponding to one or more services. The same device may correspond to a provider device with regard to a first service and a subscriber device with regard to a second service. As referred to herein, a “publisher” device refers to a provider device.

A data link group may be initiated by a provider device of the NAN sending a message (e.g., a service advertisement) to electronic devices of the NAN during a discovery window (DW). The service advertisement may indicate that the provider device is available to provide a particular service. The service advertisement may include a schedule advertisement. For example, the service advertisement may include a data link group schedule that indicates one or more time-blocks (TBs) during which the provider device is available to provide the particular service. As referred to herein, a “schedule”, a “data link group schedule”, a “transmission schedule”, or a “data transmission schedule” may be used interchangeably. As referred to herein, a “TB” and a “transmission TB” may be used interchangeably

In a particular aspect, the provider device may send a first frame that includes a service advertisement and may send a second frame that includes a schedule advertisement. The provider device may send the first frame during a first discovery window and may send the second frame during a second discovery window, during a further availability window (FAW) of the NAN channel, or both. The first discovery window may be the same as, or distinct from, the second discovery window. In a particular aspect, the provider device may send the service advertisement to a subscriber device in response to receiving a service discovery message from the subscriber device. In this aspect, the provider device may refrain from sending the service advertisement during a discovery window in response to determining that no service discovery message has been received during the discovery window. The provider device may send the schedule advertisement during a discovery window irrespective of receiving a service discovery message during the discovery window. As referred to herein, a “publish” message refers to a service discovery message sent by the provider device. As referred to herein, a “subscription” message refers to a service discovery message sent by a subscriber device. The subscription message may correspond to a request from the subscriber device. The publish message may correspond to a response to the subscription message.

As referred to herein, a “discovery window” refers to a time period corresponding to an active operating mode of the electronic devices of the NAN. During the discovery window, one or more of the electronic devices of the NAN may monitor a NAN communication channel for service advertisements. The NAN communication channel may correspond to a particular wireless channel.

The service may have a target quality of service (QoS). The target QoS may include target latency, a target data rate, or both. Latency may indicate a wait time between a queue time and a transmit time. The queue time may indicate when data is available for transmission from the provider device to a subscriber device. For example, the queue time may indicate a time at which the data is added to a transmission buffer (e.g., a memory buffer) of the provider device. The transmit time may indicate when the data is transmitted from the provider device to the subscriber device. Latency may correspond to a delay between the queue time and the transmit time. In a particular aspect, latency may indicate a difference between transmit times of consecutive packets in a data stream. For example, latency may correspond to a difference between a first transmit time of a first packet of a data stream and a second transmit time of a second packet that is consecutive to the first packet in the data stream. The target latency may indicate a latency threshold (e.g., 20 milliseconds (msec)). Data rate may indicate a number of bits of the data transmitted per unit of time (e.g., a second). The target data rate may indicate a data rate threshold (e.g., 2 megabits per second (Mbits/sec)).

The provider device may determine the schedule to satisfy the target latency, the target data rate, or both. For example, the provider device may determine a time interval between consecutive time-blocks of the schedule that is less than the target latency (e.g., 20 msec). The provider device may determine a size of each time-block of the schedule based at least in part on the target data rate (e.g., 2 Mbits/sec) and an estimated physical (PHY) rate. The estimated PHY rate may account for capabilities of a transmitter of the provider device. In a particular aspect, the estimated PHY rate may be based on a default PHY rate, a configuration property, a detected PHY rate of the transmitter, the capabilities of the transmitter, or a combination thereof. For example, a transmitter may be capable of transmitting at a first rate (e.g., 300 megabits per second (Mbps)). The transmitter may transmit at a second rate (e.g., 54 Mbps) due to various network conditions. The estimated PHY rate may be less than or equal to the second rate. In a particular aspect, the transmitter may transmit at a lower rate during an initial stage of transmission and at a higher rate during a later stage of transmission. The provider device may initially determine the estimated PHY rate based on a conservative estimation. The provider device may update (e.g., increase) the estimated PHY rate over time, as described herein. In a particular aspect, the provider device and one or more subscriber devices may negotiate an initial value of the estimated PHY rate during data link setup. For example, the initial value of the estimated PHY rate may be indicated in a negotiation message sent from the provider device, a negotiation message received by the provider device, or both. Data transmission from the provider device based on the schedule may satisfy the target latency, the target data rate, or both.

A subscriber device of the NAN may respond to a service advertisement from the provider device by sending a subscription message to the provider device. In a particular aspect, the provider device may send the service advertisement to the subscriber device in response to receiving a subscription message from the subscriber device. The provider device may perform data link setup by exchanging negotiation messages with the subscriber device. For example, the provider device may send a negotiation message to the subscriber device indicating an identifier corresponding to the subscriber device. To illustrate, the provider device may assign the identifier to the subscriber device. The identifier may uniquely identify the subscriber device relative to other subscriber devices of the data link group. In a particular aspect, the subscriber device may send a proposed schedule to the provider device. The provider device may update the schedule based at least in part on availability of the subscriber device as indicated by the proposed schedule.

A particular data link group may correspond to the particular service and to the time-blocks indicated by the schedule. A time-block may refer to a time period and a particular communication channel. The particular data link group may include the provider device and one or more subscriber devices that sent a subscription message responsive to the service advertisement.

Each time-block may include a portion of time during which the provider device of the data link group may send a traffic advertisement via a corresponding communication channel to a set of subscriber devices of the data link group. The traffic advertisement may indicate availability of data to be sent by the provider device. For example, the traffic advertisement may include (or indicate) an identifier sent to a subscriber device during data link setup to indicate availability of data to be sent to the subscriber device. The portion of time may correspond to a paging window (PW), and the traffic advertisement may correspond to a paging message. Electronic devices of the data link group may monitor the (physical) communication channel during at least a portion of a PW of the time-block.

Each time-block may include a portion of time during which the provider device of the data link group may send data via the corresponding communication channel to a subset of subscriber devices of the data link group. For example, the provider device may, responsive to the traffic advertisement, receive an acknowledgment (ACK) or a data trigger (e.g., a data request) from the first subscriber device. The provider device may, in response to receiving the ACK or the data trigger, send data to a first subscriber device. The portion of time may correspond to a data transmission window. A subscriber device that sends an ACK or a data trigger responsive to the traffic advertisement may monitor the communication channel during at least a portion of the data transmission window of the time-block.

The provider device may dynamically update the schedule based on detected conditions. For example, the provider device may, based on particular packets remaining in a transmission buffer at the end of a number of time-blocks, increase a size of the time-blocks of the schedule. As another example, the provider device may, in response to determining that a wait time between a queue time and a transmit time of particular packets is greater than a threshold, reduce an interval between consecutive time-blocks of the schedule.

Particular aspects of the present disclosure are described below with reference to the drawings. In the description, common features are designated by common reference numbers throughout the drawings.

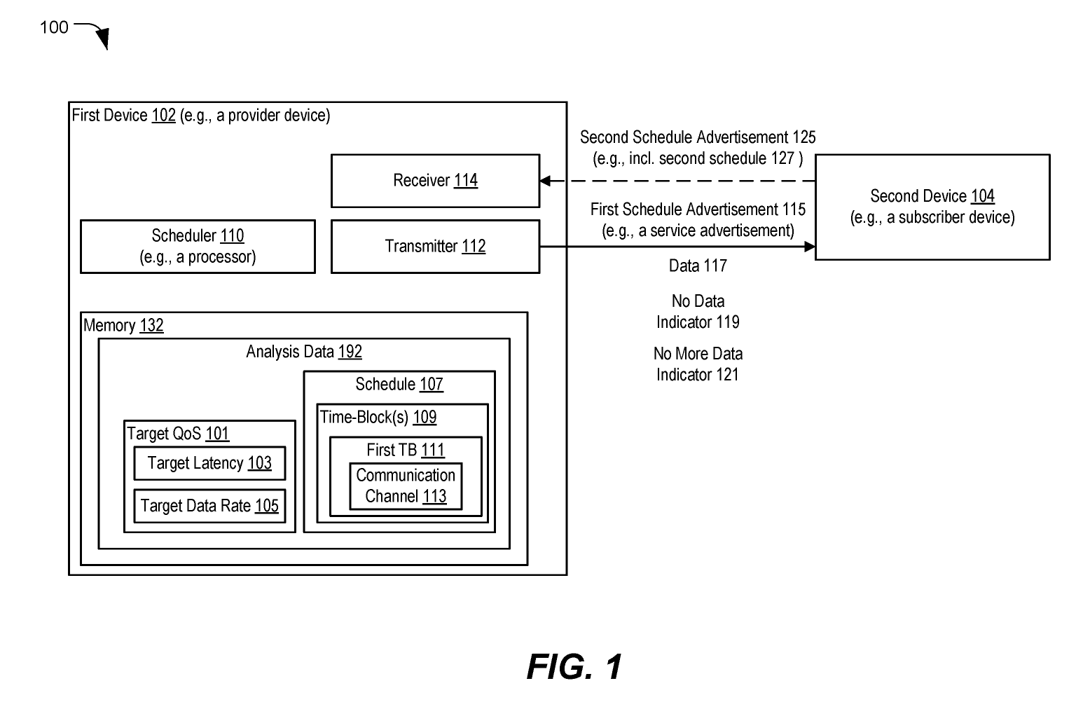

Referring to FIG. 1, a particular illustrative aspect of a system is disclosed and generally designated 100. The system 100 includes a first device 102 and a second device 104. In a particular aspect, the system 100 may include more than two devices. The first device 102 includes a scheduler 110, a transmitter 112, a receiver 114, and a memory 132. The scheduler 110 may correspond to hardware circuitry, a processor, computer-readable instructions, or a combination thereof.

The scheduler 110 may be configured to determine a target quality of service (QoS) 101, as described herein. The scheduler 110 may be configured to determine a schedule 107 based on the target QoS 101, as described herein. The schedule 107 may indicate one or more time-blocks 109. The memory 132 may be configured to store the schedule 107. The transmitter 112 may be configured to transmit data to at least one device during a time-block of the time-blocks 109 based on the schedule 107, as described herein.

The first device 102 and the second device 104 may be included in a neighbor aware network (NAN). An electronic device may be configured to perform data exchanges via wireless communications with one or more other electronic devices of the NAN. For example, the first device 102 may be configured to perform data exchanges via wireless communications with the second device 104. The data exchanges may be performed without involving wireless carriers, Wi-Fi access points, or the Internet. The timing and operations described herein are illustrative and are not limiting. In other aspects, additional or fewer operations may be performed and the timing may be different.

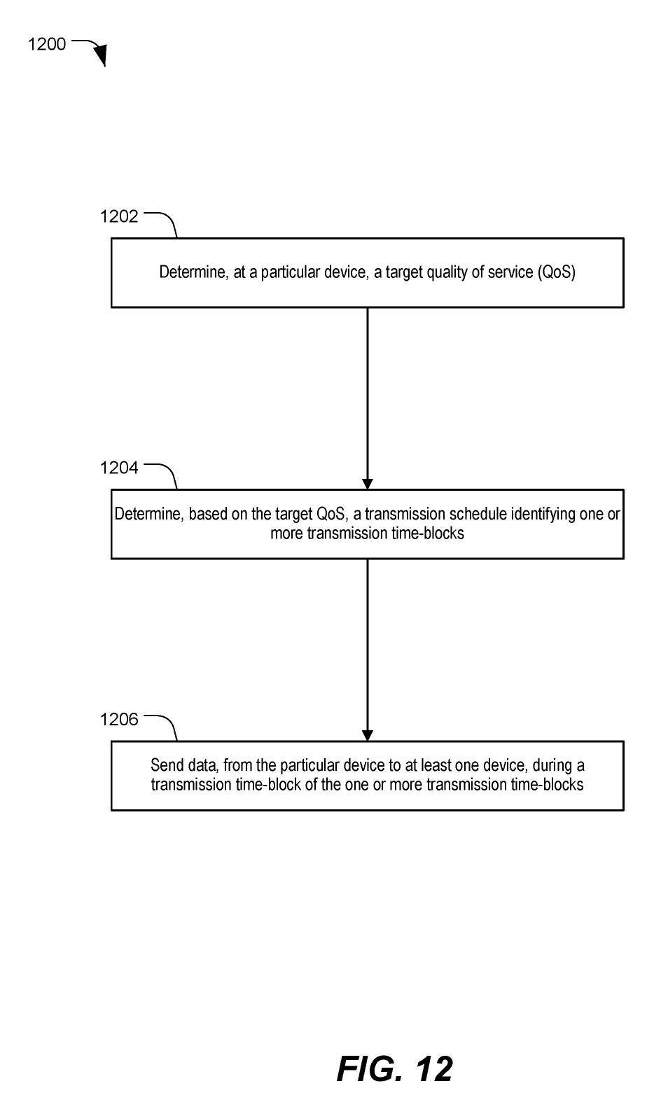

The first device 102, the second device 104, or both, may include fixed location electronic devices or mobile electronic devices. For example, the first device 102, the second device 104, or both, may include or correspond to mobile phones, laptop computers, tablet computers, personal computers, multimedia devices, peripheral devices, data storage devices, or a combination thereof. Additionally or alternatively, the first device 102, the second device 104, or both, may include a processor, a memory, and a transceiver configured to send and receive data via one or more wireless networks, as further described with reference to FIG. 12. The processor may include at least one of a central processing unit (CPU), a digital signal processor (DSP), a network processing unit (NPU), or another processing unit. The memory may include at least one of a random access memory (RAM), a read-only memory (ROM), or another memory. The transceiver may include a wireless receiver and a wireless transmitter. The wireless networks may be associated with one or more wireless communication channels. Although certain operations described herein may be described with reference to a “transceiver,” in other aspects a “receiver” may perform data receiving operations and a “transmitter” may perform data transmitting operations.

The devices 102-104 may exchange data, services, or both, via one or more wireless networks. As used herein, a transmission “via” a wireless network may include, but is not limited to, a “point-to-point” transmission between two electronic devices of the wireless network. A point-to-point transmission may correspond to unicast transmission. As another example, a transmission via the wireless network may include a communication that is “broadcast” from a particular electronic device of the wireless network to multiple other electronic devices of the wireless network. The devices 102-104 may be configured to operate in accordance with one or more wireless protocols or standards, such as an Institute of Electrical and Electronics Engineers (IEEE) 802.11 standard. For example, the devices 102-104 may operate in accordance with at least one of an IEEE 802.11a, b, g, n, s, aa, ac, ad, ae, af, ah, ai, aj, aq, ax, or mc standard. Additionally, the devices 102-104 may operate in accordance with one or more NAN standards or protocols.

One or more of the devices 102-104 may be configured to communicate with a cellular network via one or more cellular communication protocols or standards, such as a code division multiple access (CDMA) protocol, an orthogonal frequency division multiplexing (OFDM) protocol, an orthogonal frequency division multiple access (OFDMA) protocol, a time division multiple access (TDMA) protocol, a space division multiple access (SDMA) protocol, a carrier sense multiple access (CSMA) protocol, etc. Additionally, one or more of the devices 102-104 may be configured to operate in accordance with one or more near-field communications standards, such as a Bluetooth® standard (Bluetooth is a registered trademark of Bluetooth SIG, Inc. of Kirkland, Wash.). Additionally, one or more of the devices 102-104 may exchange data via infrared or other near-field communications.

The devices 102-104 may enter and exit the NAN at various times during operation. For example, an electronic device that is not within the NAN may detect a discovery beacon and may associate with the NAN during a discovery window identified by the discovery beacon, in accordance with a NAN standard or protocol. Additionally, the devices 102-104 may disassociate from the NAN at any time. While within the NAN, the devices 102-104 may be configured to transmit or to receive messages indicating an availability to communicate based on one or more schedules. For example, the devices 102-104 may be configured to transmit or to receive schedule advertisements that advertise a service provided based on a schedule by at least one electronic device of the NAN. A schedule advertisement may include or correspond to, or be included within a service discovery frame (SDF).

Additionally, while within the NAN, the devices 102-104 may be configured to transmit or to receive synchronization beacons. A synchronization beacon may indicate synchronization information and may be formed in accordance with one or more NAN standards or protocols. The devices 102-104 may be configured to synchronize respective internal clocks based on the synchronization beacons. Because the internal clocks of the devices 102-104 may be synchronized, the devices 102-104 may determine a common time period to transition to an active operating mode and monitor the NAN communication channel for a schedule advertisement. The common time period may correspond to the discovery window of the NAN.

The devices 102-104 of a data link group may also use the synchronization information to determine a common time period to transition to the active operating mode and monitor a particular communication channel corresponding to a particular time-block for a traffic advertisement. The common time period may correspond to a paging window of the data link group.

The synchronization beacons may be retransmitted (e.g., rebroadcast) by the devices 102-104 within the NAN, in accordance with a NAN standard or protocol, to enable the synchronization beacons to reach electronic devices that are beyond a wireless communication range of the electronic device that transmits the synchronization beacon. In a particular aspect, the synchronization beacons may be transmitted between electronic devices of the NAN via a first wireless channel. The first wireless channel may correspond to a “NAN communication channel.” As referred to herein, a “NAN communication channel” is a particular wireless channel that is reserved for electronic devices to perform NAN discovery operations and NAN synchronization operations.

In addition to being included in the NAN, the device 102-104 may be included in one or more data link groups. Thus, a NAN may include zero or more data link groups, and each device in the NAN may be a member of zero or more data link groups. A data link group may correspond to a service provided based on one or more schedules by one or more provider devices of the NAN. For example, in FIG. 1, the first device 102 may provide a particular service based on the schedule 107 to subscriber devices of the data link group, as described herein. The particular service may include at least one of a music service, a gaming service, a social media service, an advertising service, or a message sharing service. In a particular aspect, one or more additional provider devices may also provide the particular service via one or more schedules to the subscriber devices. As another example, the first device 102 may be part of another network, and the first device 102 may be configured to advertise the other network to enable other electronic devices of the NAN to join the other network via the first device 102. The other network may include an access point (AP) based network or an independent basic service set (IBSS) network.

Data path links may include “single-hop” data link groups, “multi-hop” data link groups, or both. A single-hop data link group may include one or more electronic devices that are within a wireless communication range of a provider device. A multi-hop data link group may include one or more electronic devices that are outside a wireless communication range of the first device 102. In the multi-hop data link group, at least one electronic device may receive a message (including data) from the first device 102 and may rebroadcast the message to another electronic device that is outside of the wireless communication range of the first device 102. In a particular aspect, a multi-hop data link group may include the first device 102, the second device 104, and a third device. In this aspect, wireless communications from the first device 102 to the third device may be routed by the second device 104. For example, the second device 104 may retransmit wireless communications received from the first device 102 to the third device. In another particular aspect, the data link group may be a single-hop data link group that includes the first device 102, the second device 104, one or more additional devices, or a combination thereof.

The first device 102 may operate as a data source and may transmit data to other electronic devices of the data link group. For example, to share a music service, the first device 102 may transmit music data to another electronic device in the data link group. As another example, to share a social media service, the first device 102 may transmit text data, image data, video data, or a combination thereof, to another electronic device in the data link group. As a further example, to share a gaming service, the first device 102 may transmit text data, score data, image data, video data, or a combination thereof, to another electronic device in the data link group. The other electronic devices may be configured to operate as data sinks. For example, the second device 104 may be a subscriber device that is configured to operate as a data sink.

In a particular aspect, data may be transmitted between electronic devices of the data link group via one or more “data link group” channels. As used herein, a “data link group channel” is a particular wireless channel that is reserved for electronic devices in a corresponding data link group to communicate messages regarding sharing a service and to communicate data associated with the service. The messages may include traffic advertisements, service data, etc. Data may be transmitted between electronic devices of the data link group via one or more data link group channels during time-blocks. The data link group channel may also be used for sharing security information, for performing association operations, and for performing routing operations in multi-hop data link groups.

In some aspects, a data link group channel and the NAN communication channel may be different wireless channels that correspond to different wireless frequency bands. In a particular aspect, the NAN communication channel may be a 2.4 gigahertz (GHz) channel, and the data link group channel may be a 5 GHz channel. In other aspects, the data link group channel and the NAN communication channel may be the same wireless channel. For example, the devices 102-104 may share data associated with the data link group via the NAN communication channel. In some aspects, the NAN may include multiple data link groups. A first data link group of the multiple data link groups may correspond to a first data link group channel. A second data link group of the multiple data link groups may correspond to a second data link group channel. The first data link group channel may be distinct from the second data link group channel. In an alternate aspect, the first data link group channel may be the same as the second data link group channel. In yet another aspect, the first data link group channel may overlap the second data link group channel. The multiple data link groups may correspond to different services provided by various electronic devices in the NAN. In some aspects, electronic devices of the multiple data link groups may share data via the same data link group channel during distinct time-blocks.

During operation, one of the electronic devices of the NAN may generate and transmit a synchronization (sync) beacon in accordance with a NAN standard or protocol. For example, the second device 104 may transmit the synchronization beacon via the NAN communication channel. Electronic device(s) within a one-hop range of the second device 104 may retransmit the synchronization beacon so that the synchronization beacon propagates throughout the NAN. The first device 102 may receive the synchronization beacon and may perform synchronization operations based on the synchronization beacon. For example, the first device 102 may synchronize timing circuitry based on receiving the synchronization beacon. The timing circuitry may include an internal clock.

The first device 102 may, after performing the synchronization operations, begin providing a particular service to other devices of the NAN, as described herein. The scheduler 110 may determine the target QoS 101. In a particular aspect, the target QoS 101 may be provided by an application corresponding to the particular service. For example, the particular service may correspond to a particular application and the scheduler 110 may determine the target QoS 101 by querying the particular application. In an alternate aspect the target QoS 101 may correspond to a default parameter. In a particular aspect, the first device 102 may receive the target QoS 101 from a subscriber device (e.g., the second device 104). In a particular aspect, the scheduler 110 may, in response to determining that no target QoS is associated with the particular service, determine the target QoS 101 based on a default value. The scheduler 110 may determine the schedule 107 based on the target QoS 101, as described herein. The scheduler 110 may update the schedule 107, as described herein. For example, the scheduler 110 may update the schedule 107 associated with the particular service over time based on traffic patterns associated with the particular service. The first device 102 may store the updated schedule 107 in the memory 132. The memory 132 may include a service identifier indicating that the schedule 107 (e.g., the updated schedule 107) corresponds to the particular service.

The scheduler 110 may use the schedule 107 in response to a subsequent activation of the particular service. For example, the scheduler 110 may, in response to a subsequent activation of the particular service, determine that no target QoS is associated with the particular service. The scheduler 110 may, in response to determining that no target QoS is associated with the particular service and determine that a schedule (e.g., the schedule 107) associated with the particular service is stored in the memory 132, exchange data corresponding to the particular service based on the schedule 107. For example, the scheduler 110 may send or receive packets associated with the particular service based on the schedule 107. Alternatively, the scheduler 110 may, in response to determining that no schedule associated with the particular service is stored in the memory 132, determine the target QoS 101 based on a default value and may determine the schedule 107 based on the target QoS 101.

In a particular aspect, the scheduler 110 may receive information (e.g., profile information) from the application, a subscriber device, or both, and may determine the target QoS 101 based on the information. For example, the scheduler 110 may receive information indicating that the particular service corresponds to a particular profile (e.g., a gaming profile, a music profile, or a voice over internet protocol (VOIP) profile). The scheduler 110 may determine the target QoS 101 based on a default QoS value (e.g., 20 msec latency and 500 kilobits per second (Kbps) data rate) corresponding to the particular profile (e.g., a VOIP profile). The default QoS value may be specified in one or more wireless protocols or standards, such as an Institute of Electrical and Electronics Engineers (IEEE) 802.11 standard. The scheduler 110 may store an identifier in the memory 132 indicating that the particular service corresponds to the particular profile.

The target QoS 101 may include target latency 103, a target data rate 105, or both. The target latency 103 (e.g., 20 msec) may indicate a latency threshold (e.g., a maximum latency). The particular service may produce first data at a first time. The transmitter 112 may transmit the first data at a second time. In a particular aspect, the target latency 103 may be satisfied when a difference between the first time and the second time is less than or equal to the latency threshold. In an alternate aspect, the target latency 103 may be satisfied when a difference between the second time and a transmit time of second data is less than or equal to the latency threshold. The first data may be consecutive to the second data in a data stream that is produced by the particular service. The target data rate 105 (e.g., 2 Mbits/sec) may indicate a data rate threshold (e.g., a minimum data rate). The transmitter 112 may transmit a first number of bits during a “discovery interval.” A discovery interval may refer to a time period between two consecutive discovery windows. The target data rate 105 (e.g., 2 Mbits/sec) may be satisfied when a ratio of the first number of bits relative to the time period (e.g., first number of bits/time period) is greater than or equal to the data rate threshold.

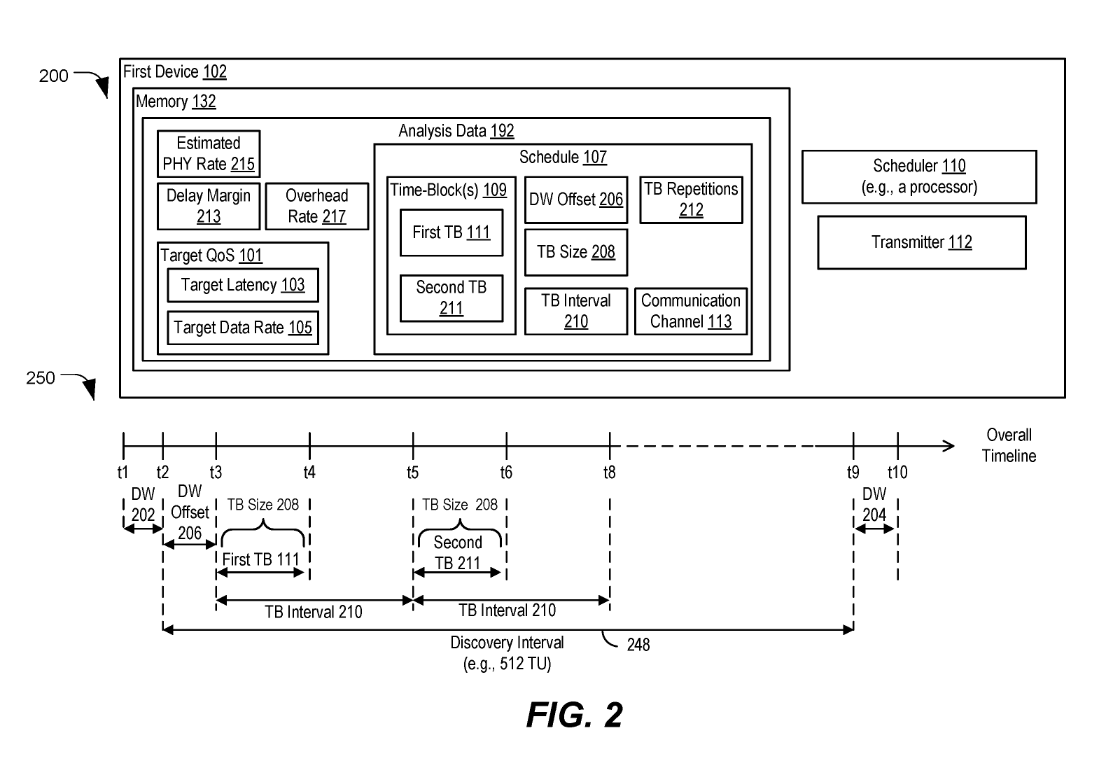

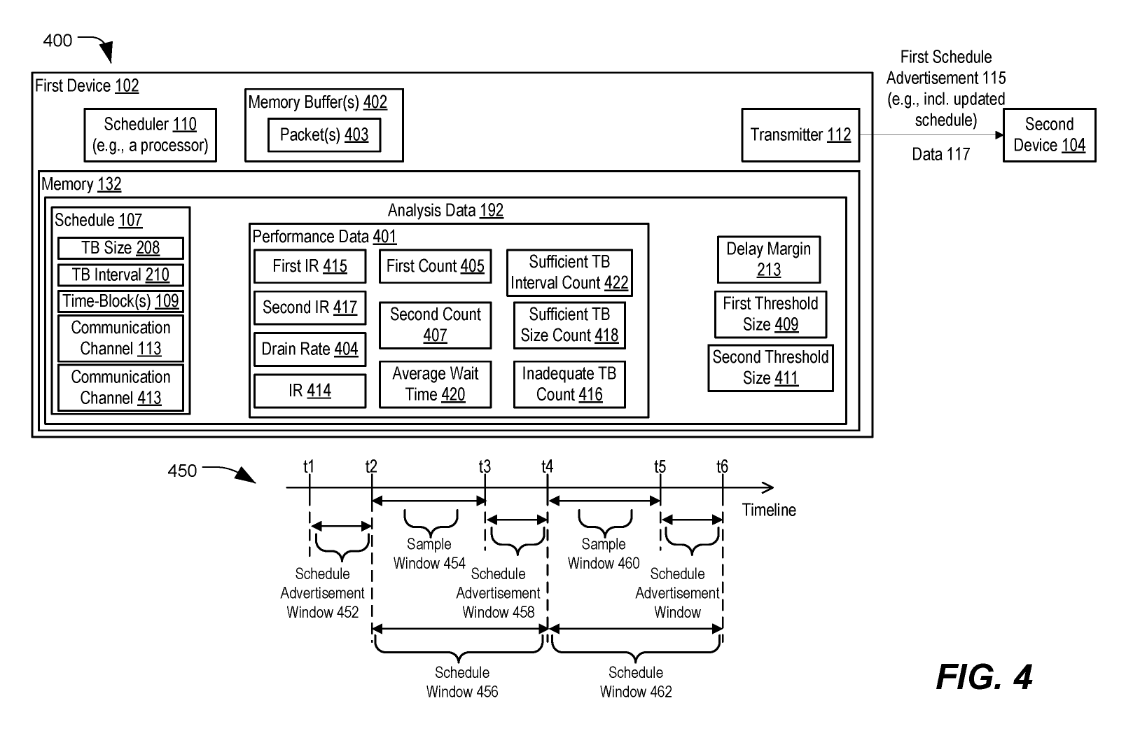

The scheduler 110 may store the target QoS 101 in the memory 132. For example, the memory 132 may include analysis data 192. The scheduler 110 may store the target QoS 101 as part of the analysis data 192 in the memory 132. The scheduler 110 may determine the schedule 107 (e.g., a baseline schedule) by analyzing the analysis data 192. For example, the scheduler 110 may determine the schedule 107 based at least in part on the target QoS 101, as further described with reference to FIG. 2-8. The scheduler 110 may store the schedule 107 as part of the analysis data 192 in the memory 132. In a particular aspect, the scheduler 110 may update the schedule 107 over time, as further described with reference to FIG. 4.

The schedule 107 may indicate the time-blocks (TBs) 109. The TBs 109 may occur during a discovery interval between two consecutive discovery windows (DWs). The TBs 109 may be associated with one or more communication channels. For example, one or more first TBs may be associated with a first communication channel, one or more second TBs may be associated with a second communication channel, one or more third TBs may be associated with a third communication channel, and so on. The first communication channel may be the same as or distinct from the second communication channel, the second communication channel may be the same as or distinct from the third communication channel, or a combination thereof. The first TBs, the second TBs, the third TBs, or a combination thereof, may be in any order in the data link group schedule. For example, the data link group schedule may include a first time-block (TB) associated with a first communication channel, a second TB associated with a second communication channel, a third TB associated with the first communication channel, a fourth TB associated with a third communication channel, a fifth TB associated with the first communication channel, a sixth TB associated with the third communication channel, a seventh TB associated with the third communication channel, or a combination thereof. The first communication channel may be the same as or distinct from the second communication channel. The second communication channel may be the same as distinct from the third communication channel. The first communication channel may be the same as or distinct from the third communication channel. For example, one or more of the first communication channel, the second communication channel, or the third communication channel may correspond to a first frequency band (e.g., a 2.4 gigahertz (GHz) wireless communication channel), a second frequency band (e.g., a 5 GHz wireless communication channel), or a third frequency band (e.g., a 60 GHz wireless communication channel).

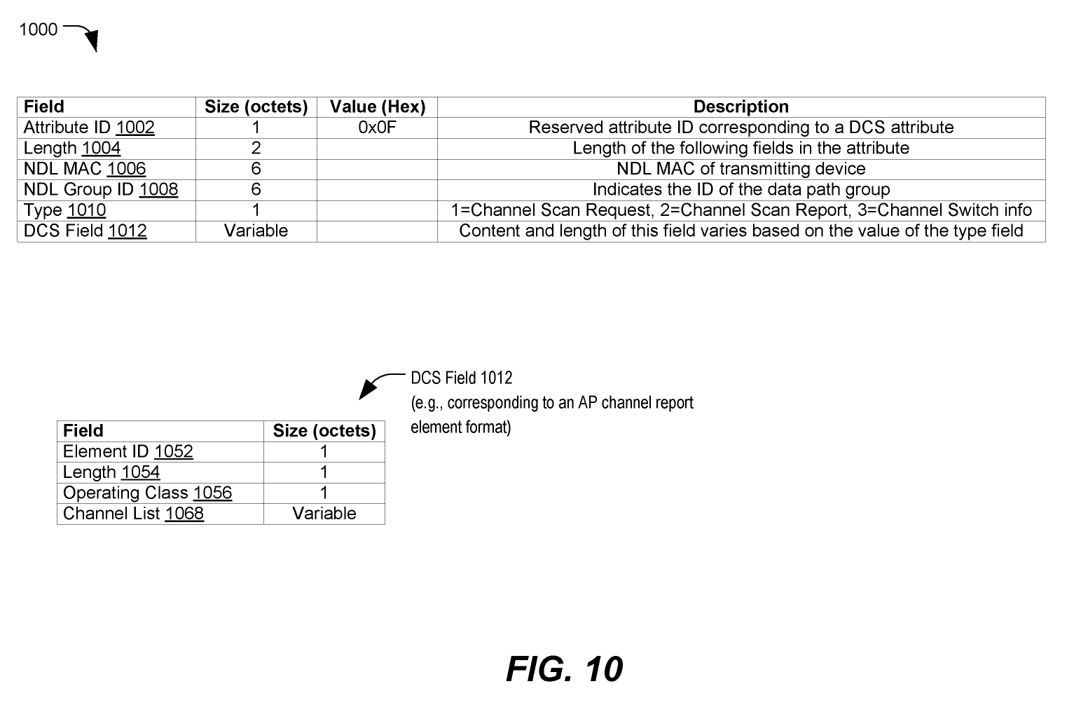

In a particular aspect, the TBs 109 may include a first TB 111. The first TB 111 may correspond to a time period and a communication channel 113. The communication channel 113 may include a physical wireless communication channel. In a particular aspect, each of the time-blocks 109 may correspond to the same communication channel (e.g., the communication channel 113). The communication channel 113 may correspond to a default channel. For example, a configuration parameter may indicate the communication channel 113. The scheduler 110 may initialize the schedule 107 to correspond to the communication channel 113 based on the configuration parameter. The scheduler 110 may subsequently update the schedule 107 such that one or more of the time-blocks 109 correspond to another communication channel based on a channel scan, as further described with reference to FIGS. 4 and 10.

In a particular aspect, the time-blocks 109 may correspond to a plurality of communication channels. For example, the first TB 111 may correspond to the communication channel 113 and a second TB of the time-blocks 109 may correspond to a second communication channel that is distinct from the communication channel 113.

The plurality of communication channels may include a 900 megahertz (MHz) wireless communication channel, a 2.4 GHz wireless communication channel, a 3.65 GHz wireless communication channel, a 4.9 GHz wireless communication channel, a 5 GHz wireless communication channel, a 5.9 GHz wireless communication channel, a 60 GHz wireless communication channel, or a combination thereof. For example, the plurality of communication channels may include an IEEE channel 1 in a 2.4 GHz frequency band, an IEEE channel 11 in a 2.4 GHz frequency band, or both. The communication channel 113 may include a 2.4 GHz wireless communication channel or a 5 GHz wireless communication channel. For example, the communication channel 113 may include the IEEE channel 1 in the 2.4 GHz frequency band or the IEEE channel 11 in the 2.4 GHz frequency band.

The scheduler 110 may generate a first schedule advertisement 115 indicating that the first device 102 is available to provide the particular service based on the schedule 107. For example, the scheduler 110 may generate a frame that includes the first schedule advertisement 115. To illustrate, the frame may include an attribute that indicates the schedule 107, an attribute that indicates whether the particular service corresponds to an updated schedule, or a both. In a particular aspect, the frame (e.g., a SDF) may also include a service advertisement. In an alternate aspect, a service advertisement may not be included in the frame (e.g., a NAN management frame (NMF)). The transmitter 112 may transmit the frame during a NAN discovery window or outside a NAN discovery window. For example, the transmitter 112 may transmit, via the NAN channel, the frame during a further availability window (FAW) of the NAN. In a particular aspect, the transmitter 112 may transmit the frame via a communication channel (e.g., the communication channel 113) associated with a data path link. In a particular aspect, a service discovery message may include the first schedule advertisement 115.

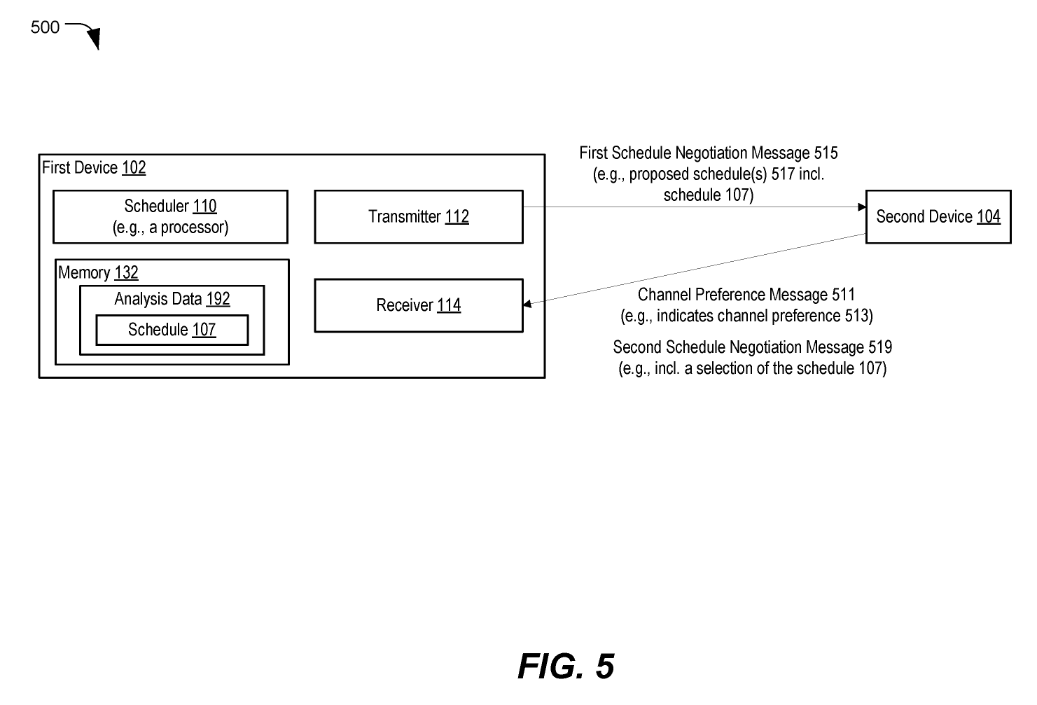

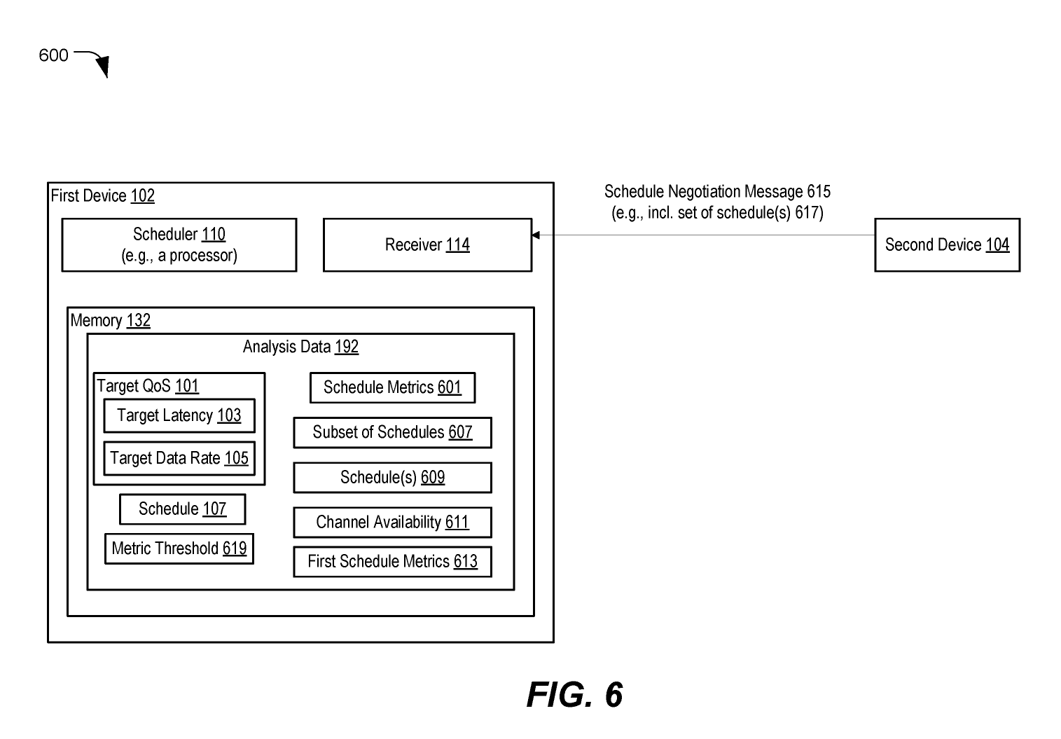

In a particular aspect, the schedule 107 may be negotiated during data link setup. The first schedule advertisement 115 may be included in a negotiation message, as further described with reference to FIGS. 5-6. In a particular aspect, the first device 102 may receive, via the receiver 114, a second schedule advertisement 125 from the second device 104. The second schedule advertisement 125 may indicate a second schedule 127. The scheduler 110 may select one of the schedule 107 and the second schedule 127, as further described with reference to FIG. 6. The first schedule advertisement 115 may indicate the selected one of the schedule 107 and the second schedule 127. For example, the first schedule advertisement 115 may indicate the schedule 107.

In a particular aspect, the first device 102 may provide the particular service via the NAN channel. For example, each of the time-blocks 109 may correspond to the communication channel 113 and the communication channel 113 may correspond to the NAN channel. The time-blocks 109 may correspond to one or more transmissions windows that follow a NAN discovery window. In a particular aspect, the first schedule advertisement 115 may not indicate the NAN channel. Thus, the second device 104 may assume that the first device 102 is available to provide the particular service via the NAN channel in response to receiving the first schedule advertisement 115 irrespective of whether the first schedule advertisement 115 indicates the NAN channel. In a particular aspect, the communication channel 113 may be distinct from the NAN channel and the first schedule advertisement 115 may indicate the communication channel 113.

The first device 102 may send the first schedule advertisement 115 to one or more devices of the NAN during a NAN discovery window. The one or more devices may include the second device 104. The second device 104 may monitor the NAN channel during the NAN discovery window. The second device 104 may receive the first schedule advertisement 115 during the NAN discovery window. One or more devices of the NAN may send a subscription message in response to receiving the first schedule advertisement 115. The first device 102 may determine that the one or more devices are available to receive the particular service based on receiving the subscription message. For example, the first device 102 may, in response to receiving a subscription message from the second device 104, determine that the second device 104 is available to communicate during at least some of the time-blocks 109 via corresponding communication channel(s). To illustrate, the first device 102 may determine that the second device 104 is available to communicate, via the communication channel 113, during the first TB 111.

In a particular aspect, the first device 102 may receive subscription messages from multiple subscriber devices. For example, the first device 102 may receive a subscription message from the second device 104 and one or more additional devices. A data link group corresponding to the schedule may include the first device 102 and each subscriber device from which the first device 102 receives a subscription message responsive to the first schedule advertisement 115. A data link identifier may correspond to (e.g., indicate) the data link group. In a particular aspect, the first device 102 may generate the data link identifier and may provide the data link identifier to each subscriber device (e.g., the second device 104) from which the first device 102 receives a subscription message.

Electronic devices participating in a data link group may monitor one or more communication channels during a beginning portion of at least some of the time-blocks 109. The beginning portion may correspond to a paging window (PW). For example, the first device 102 and the second device 104 may monitor the communication channel 113 during a PW of the first TB 111. In a particular aspect, devices participating in a data link group may monitor communication channel(s) during paging window(s) corresponding to at least a first number of the time-blocks 109.

Each of the devices 102-104 may have at least two operating modes. For example, a first operating mode may correspond to an active operating mode. While operating in the active mode, a particular device monitors a first communication channel. The first communication channel may include the communication channel 113. Each of the devices 102-104 may be expected to operate in the active mode during at least a portion of a PW of the first TB 111.

As another example, a second operating mode of the device 102-104 may correspond to a low-power operating mode. While operating in the second operating mode, a particular device refrains from monitoring the first communication channel, monitors a second communication channel that is distinct from the first communication channel, performs actions related to another network, or a combination thereof. The other network may include a Bluetooth® network (Bluetooth is a registered trademark of Bluetooth SIG, Inc. of Kirkland, Wash.), a Long-Term Evolution (LTE®) network (LTE is a registered trademark of Institut Européen des Normes of France), a LTE in unlicensed spectrum (LTE-U) network, or another network.

A particular device of the devices 102-104 may transition to the second operating mode during at least a portion of a window. The window may include the first TB 111, a PW of the first TB 111, or a data transmission window of the first TB 111. For example, the particular device may determine an idle time of the window during which no traffic is detected on the first communication channel. The particular device may, in response to determining that the idle time satisfies a threshold, transition to the second operating mode during a remaining portion of the window.

The scheduler 110 may determine whether the first device 102 has data to send to the second device 104 during the first TB 111. It should be understood that the scheduler 110 may correspond to multiple logical components. The multiple logical components may operate in conjunction with each other. For example, the scheduler 110 may include a schedule generator, a data link manager, or both. The schedule generator may be configured to generate the schedule 107, as described herein. The data link manager may be configured to initiate a transmit operation, initiate a receive operation, or both, based on information provided by the schedule generator. For example, the schedule generator may provide the schedule 107 to the data link manager. The data link manager may, in response to determining that the schedule 107 indicates the first TB 111, determine whether the first device 102 has data to send to the second device 104 during the first TB 111. One or more operations described herein with reference to the scheduler 110 may be performed by the schedule generator, the data link manager, or both.

The scheduler 110 may, in response to determining that the first device 102 does not have data to send to the second device 104, send a no data indicator 119 via the transmitter 112 to the second device 104. The transmitter 112 may transmit the no data indicator 119 during a paging window of the first TB 111, a data transmission window of the first TB 111, or both. For example, the scheduler 110 may generate a traffic advertisement including the no data indicator 119. The transmitter 112 may transmit the traffic advertisement during the paging window. As another example, the transmitter 112 may transmit the no data indicator 119 during the data transmission window.

The scheduler 110 may, in response to determining that the first device 102 has data 117 to send to the second device 104, send the data 117 via the transmitter 112 to the second device 104. The transmitter 112 may transmit the data 117, via the communication channel 113, during the data transmission window. The scheduler 110 may, subsequent to sending the data 117 to the second device 104, send additional data to the second device 104 via the communication channel 113 during the data transmission window.

The scheduler 110 may, in response to determining that the first device 102 has no additional data to send to the second device 104 during the data transmission window, send a no more data indicator 121 via the communication channel 113 to the second device 104. In a particular aspect, the scheduler 110 may send the no more data indicator 121 concurrently with the data 117. For example, a value of a field of a frame may correspond to the no more data indicator 121 and the frame may include the data 117. In an alternate aspect, the scheduler 110 may send the no more data indicator 121 subsequent to sending the data 117. In a particular aspect, the no more data indicator 121 may correspond to a unicast frame with an end of service period (EOSP) field (e.g., a particular bit) having a particular value (e.g., 1), a MORE field (e.g., a particular bit) having a particular value (e.g., 0), or both. In an alternate aspect, the no more data indicator 121 may correspond to a multicast frame with an EOSP field (e.g., a particular bit) having a particular value (e.g., 1), a MORE field (e.g., a particular bit) having a particular value (e.g., 0), or both. The scheduler 110 may update the schedule 107 based on whether the no more data indicator 121 is sent during the first TB 111, as further described with reference to FIG. 4. For example, the scheduler 110 may maintain data indicating a number of TBs during which the transmitter 112 sent (or did not send) the no more data indicator 121 over a particular duration. The scheduler 110 may determine whether a size (e.g., a TB size) of the TBs 109 is to be updated (e.g., increased or decreased) based on the number.

The second device 104 may, in response to receiving the no data indicator 119 or the no more data indicator 121, transition to the second operating mode during a remaining portion of the first TB 111. The scheduler 110 may, in response to determining that the first device 102 has no data (or no additional data) to transmit to any device of the data link group during the first TB 111, transition the first device 102 to the second operating mode during a remaining portion of the first TB 111.

In a particular aspect, the target latency 103 (e.g., 20 msec) may be lower than a rate at which data is generated by the particular service (e.g., approximately every 50 msec). Each of the first device 102 and the second device 104 may transition to the active operating mode based on the target latency 103 (e.g., approximately every 20 msec) to determine whether there is data to be exchanged between the first device 102 and the second device 104. The first device 102 may send the no data indicator 119 in response to determining that there is no data to be sent to the second device 104. The system 100 may conserve resources while satisfying the target latency 103 by having the second device 104 transition to the second operating mode in response to receiving the no data indicator 119 and by having the first device 102 transition to the second operating mode in response to determining that there is no data (or no additional data) to be sent to any device of the data link group during the first TB 111.

The first device 102, the second device 104, or both, may transition to (or remain in) the active operating mode during a second paging window of the second TB of the time-blocks 109. The scheduler 110 may, in response to determining that the first device 102 has second data to send to the second device 104 during the second TB, send a traffic advertisement via the second communication channel during the second paging window. The first device 102, the second device 104, or both, may transition to (or remain in) the active operating mode during a second data transmission window of the second TB. The first device 102 may send, via the second communication channel, the second data to the second device 104. The second device 104 may receive the second data via the second communication channel. The first device 102 may thus send data using multiple communication channels at various times based on the schedule 107.

In a particular aspect, the first device 102 may transition to the second operating mode during at least a portion of a time-block (e.g., the first TB 111) in response to determining that no data is to be sent or received by the first device 102 during the time-block. The scheduler 110 may determine that no data is to be sent by the first device 102 during the time-block (e.g., the first TB 111) in response to determining that the scheduler 110 has not sent any traffic advertisements (e.g., announcement traffic indication message (ATIM) frames) during a paging window of the time-block that indicate that the first device 102 has data to send during the time-block. The scheduler 110 may refrain from sending a traffic advertisement during the paging window for various reasons. For example, the scheduler 110 may refrain from the sending any traffic advertisements in response to determining that there is no data available to be sent during the paging window. As another example, the scheduler 110 may refrain from sending any traffic advertisements in response to receiving an instruction to refrain from sending data during the time-block irrespective of availability of data to be sent during the time-block.

In a particular aspect, the first device 102 may refrain from sending data when a corresponding traffic advertisement is not acknowledged. In this aspect, the first device 102 may determine that no data is to be sent by the first device 102 during the time-block in response to determining that the first device 102 has sent a traffic advertisement during a paging window of the time-block and no ACK responsive to the traffic advertisement has been received during the paging window. In an alternate aspect, the first device 102 may determine, irrespective of whether a traffic advertisement is acknowledged, whether data is to be sent by the first device 102 during a time-block.

In a particular aspect, a subscriber device (e.g., the second device 104) may send an ACK in response to receiving a traffic advertisement corresponding to unicast data and may refrain from sending an ACK in response to receiving a traffic advertisement corresponding to broadcast data (or multicast data). The scheduler 110 may determine whether data is to be sent by the first device 102 based on receiving an ACK when a traffic advertisement corresponds to unicast data and irrespective of receiving an ACK when a traffic advertisement corresponds to broadcast data (or multicast data). For example, the scheduler 110 may send a traffic advertisement during a paging window of a time-block and the traffic advertisement may indicate availability of unicast data. In this example, the scheduler 110 may determine that no data is to be sent by the first device 102 during the time-block in response to determine that the traffic advertisement indicates availability of unicast data and that no ACK responsive to the traffic advertisement has been received during the paging window. As another example, the scheduler 110 may send a traffic advertisement during a paging window of a time-block and the traffic advertisement may indicate availability of broadcast data (or multicast data). The scheduler 110 may, in response to determining that the traffic advertisement indicates availability of broadcast data (or multicast data), determine whether data is to be sent by the first device 102 during the time-block irrespective of whether an ACK responsive to the traffic advertisement is received during the paging window.

The scheduler 110 may determine that no data is to be received by the first device 102 during the time-block (e.g., the first TB 111) in response to determining that the first device 102 has not received any traffic advertisements during the paging window that indicate availability of data to be sent to the first device 102 during the time-block.

In a particular aspect, the first device 102 may transition to the second operating mode during a remaining portion of a time-block (e.g., the first TB 111) in response to determining that data to be sent by the first device 102 during the time-block has been sent and that the data to be received by the first device 102 during the time-block has been received. The scheduler 110 may determine that the data to be sent by the first device 102 during the time-block has been sent in response to determining that a transmission queue is empty. For example, the scheduler 110 may send a traffic advertisement indicating availability of broadcast data (or multicast data) during a paging window of a time-block. The scheduler 110 may determine that the data to be sent by the first device 102 during the time-block has been sent in response to determining that a transmission queue corresponding to the broadcast data (or the multicast data) is empty. The transmission queue may be empty when a last available frame (or packet) of the broadcast data (or the multicast data) has been sent. As another example, the scheduler 110 may send a traffic advertisement during a paging window of a time-block and the traffic advertisement may indicate availability of unicast data to be sent to one or more subscriber devices (e.g., the second device 104). The first device 102 may receive an ACK responsive to the traffic advertisement from a subset of the one or more subscriber devices. The first device 102 may determine that the data to be sent by the first device 102 during the time-block has been sent in response to determining that each transmission queue corresponding to the subset of the one or more subscriber devices is empty. A particular transmission queue may be empty when a last available frame (or packet) of the unicast data has been sent to a corresponding subscriber device.

The scheduler 110 may determine that the data to be received by the first device 102 during the time-block has been received in response to determining that the first device 102 received at least one traffic advertisement indicating availability of data to be sent to the first device 102 by a set of devices (e.g., the second device 104) during a paging window of the time-block and that the first device 102 has received the no data indicator 119 or the no more data indicator 121 from each of the set of devices during the time-block.

The system 100 may enable the first device 102 to determine a data transmission schedule (e.g., the schedule 107) based on the target QoS 101. Data transmissions based on the schedule 107 may satisfy the target QoS 101 of the particular service. The schedule 107 may enable the second device 104 to determine when to monitor a communication channel (e.g., the communication channel 113) for data transmissions from the first device 102. The second device 104 may conserve resources by transitioning to the second operating mode when data transmissions are not expected from the first device 102 based on the schedule 107.

Referring to FIG. 2, a particular aspect of a system is disclosed and generally designated 200. The system 200 may correspond to the system 100 of FIG. 1. For example, the system 100 may include one or more components of the system 200.

During operation, the scheduler 110 may determine the schedule 107 based on the target QoS 101, as described herein. The schedule 107 may indicate a TB size 208 indicating a size of each of the time-blocks 109, the communication channel 113 corresponding to each of the time-blocks 109, a DW offset 206, a TB interval 210, TB repetitions 212, or a combination thereof.

The time-blocks 109 may include a plurality of time-blocks. For example, the time-blocks 109 may include the first TB 111 and a second TB 211. The DW offset 206 may indicate a delay between an end of a NAN DW and the beginning of an initial TB of the time-blocks 109. The initial TB may include the first TB 111. The TB interval 210 may indicate a time interval between consecutive time-blocks of the time-blocks 109. For example, the second TB 211 may be consecutive to the first TB 111. The TB interval 210 may correspond to a difference between a first start time of the first TB 111 and a second start time of the second TB 211. The TB repetitions 212 may indicate a count of the time-blocks 109 during a discovery interval 248.

The scheduler 110 may determine the TB interval 210 based on the target latency 103 and a delay margin 213. For example, the scheduler 110 may determine the TB interval 210 based on the following Equation:

TB interval210=(1−delay margin 213)*target latency 103, Equation1

where the TB interval 210 corresponds to a time interval between consecutive time-blocks of the time-blocks 109 and the delay margin 213 corresponds to a delay in accessing a transmission medium at the beginning of a TB.

The delay margin 213 may include a default value, a user input value, a configuration parameter, or a combination thereof. The delay in accessing the transmission medium may be due to channel switching time, medium occupancy due to a neighboring network, or both. In a particular aspect, the scheduler 110 may track delays in switching from one communication channel to another communication channel over a time period. For example, the scheduler 110 may determine an average channel switching delay over the time period. The scheduler 110 may update the delay margin 213 based on the average channel switching delay. The scheduler 110 may query underlying hardware to determine statistics corresponding medium access delay for data transmission. The underlying hardware may include a media access controller. The scheduler 110 may update the delay margin 213 based on the statistics.

In a particular aspect, the scheduler 110 may determine a channel unusability time corresponding to a particular communication channel. For example, the scheduler 110 may determine the channel unusability time of the communication channel 113 based on the following Equation:

Channel unusability time=Channel busy time−Time used by NDL traffic, Equation 2

where the Channel busy time corresponds to a duration that the communication channel 113 is detected as busy by the scheduler 110, and the Time used by NDL traffic indicates a duration that the communication channel 113 is used for NDL operations. In a particular aspect, the channel unusability time may correspond to a percentage or ratio based on the Channel busy time and the Time used by NDL traffic (e.g., Channel unusability time=1−(Time used by NDL traffic/Channel busy time)).

The communication channel 113 may be used to perform operations related to other networks during the channel unusability time. The other networks may include a Bluetooth® network (Bluetooth is a registered trademark of Bluetooth SIG, Inc. of Kirkland, Wash.), a Long-Term Evolution (LTE®) network (LTE is a registered trademark of Institut Européen des Normes of France), a LTE-U network, or another network.

The scheduler 110 may update the delay margin 213 based on the channel unusability time. In a particular aspect, the scheduler 110 may maintain a plurality of delay margins corresponding to a plurality of communication channels. For example, the scheduler 110 may determine the delay margin 213 corresponding to the communication channel 113. The scheduler 110 may determine a second delay margin corresponding to a second communication channel.

The scheduler 110 may determine the TB size 208 based on the target data rate 105, an estimated PHY rate 215, an overhead factor 217, and the TB interval 210, as described herein. For example, the scheduler 110 may determine the TB size 208 based on the following Equation:

$$TB size 208 = \frac{( target data rate 105 * TB interval 210 )}{( estimated PHY rate 215 * overhead factor 217 )} , \qquad Equation 3$$

The overhead factor 217 may compensate for media access control (MAC) layer overhead, link layer overhead, or both. The overhead factor 217 may be based on a default value (e.g., 0.9 or 90 percent). The estimated PHY rate 215 may correspond to an estimate of a PHY rate (e.g., a physical layer data rate) of the transmitter 112. The physical layer data rate may correspond to a data rate at which the transmitter 112 communicates with a destination receiver. The PHY rate may correspond to a transmission bit rate limit of the transmitter 112. For example, the PHY rate may correspond to a maximum bit rate at which the transmitter 112 is capable of transmitting data. The estimated PHY rate 215 may be determined based on a number of factors, such as factors related to over the air propagation of a transmit signal. The estimated PHY rate 215 may be based on capabilities of the transmitter 112. For example, the estimated PHY rate 215 may be based on a received signal strength indicator (RSSI) corresponding to one or more discovery frames (e.g., SDFs). The estimated PHY rate 215 may be based on range measurements indicating a distance between the first device 102 and one or more devices (e.g., the second device 104) of the data link group. The estimated PHY rate 215 may be based on interference levels corresponding to communication between the first device 102 and the one or more devices (e.g., the second device 104) of the data link group.

In a particular aspect, the estimated PHY rate 215 may be based on a default value (e.g., 6 megabits per second (Mbits/sec)). The default value may correspond to an estimation of the capabilities of the transmitter 112. In a particular aspect, the estimated PHY rate 215 may be an underestimation of the capabilities of the transmitter 112.

The scheduler 110 may dynamically adjust the schedule 107 to reduce the TB size 208 based on detected conditions to conserve resources, as further described with reference to FIG. 4. For example, adjusting the schedule 107 based on the detected conditions may enable the schedule 107 to more closely correspond to the capabilities of the transmitter 112. Use of the no more data indicator 119 by the first device 102, as described with reference to FIG. 1, may conserve resources by enabling the first device 102, the second device 104, or both, to transition to the second operating mode when the TB size 208 is based on an underestimation of the capabilities of the transmitter 112.

The DW offset 206 may be based on a default value. In a particular aspect, the communication channel 113 may be distinct from the NAN channel. The DW offset 206 may compensate for a delay in switching from the NAN channel to the communication channel 113. The scheduler 110 may determine the TB repetitions 212 based on the discovery interval 248, the DW offset 206, the TB size 208, the TB interval 210, or a combination thereof. For example, the scheduler 110 may determine the TB repetitions 212 based on the following Equation:

$$TB repetitions 212 = floor ( \frac{\begin{matrix}discovery interval 248 - C - \\ DW offset 206 - TB size DW\end{matrix}}{TB interval DW} ) , \qquad Equation 4$$

where the discovery interval 248 (e.g., 512 time units (TU)) may correspond to a time interval between two consecutive discovery windows, C may correspond to a default value that accounts for hardware specific delays (e.g., a channel switching delay, a warm-up time, another delay, or a combination thereof), TB size DW may correspond to ceiling (TB size 208, a particular number), and TB interval DW may correspond to ceiling (TB interval 210, the particular number). The scheduler 110 may normalize the TB size 208 and the TB interval 210 to a block size corresponding to the particular number (e.g., 16 TU) to generate the TB size DW and the TB interval DW, respectively.

FIG. 2 also includes a timeline 250. The timeline 250 may correspond to the schedule 107. The timeline 250 indicates that a DW 202 begins at a time t1 and ends at a time t2. The DW offset 206 begins at the time t2 and ends at a time t3. The first TB 111 begins at the time t3 and ends at the time t4. The difference between the time t3 and the time t4 corresponds to the TB size 208. The second TB 211 begins at a time t5 and ends at a time t6. A difference between the time t3 and the time t5 corresponds to the TB interval 210. The timeline 250 may include a plurality of time-blocks during the discovery interval 248; a count of the plurality of time-blocks corresponds to the TB repetitions 212. For example, if a value of the TB repetitions 212 indicates that the schedule 107 includes more than two time-blocks, the timeline 250 may include additional time-blocks. A difference between the starting times of each time-block may correspond to the TB interval 210. For example, the timeline 250 may include a third time-block at a time t8 and a difference between the time t5 and the time t8 may correspond to the TB interval 210. The timeline 250 indicates that a DW 204 begins at a time t9 and ends at a time t10. A difference between the time t2 and the time t9 may correspond to the discovery interval 248 (e.g., 512 TU).

The first device 102 may, based on the schedule 107, determine whether there is data to be sent to the second device 104 during paging windows of the time-blocks 109. For example, the first device 102 may determine whether there is data to be sent to the second device 104 during a first paging window of the first TB 111, a second paging window of the second TB 211, and so on. To illustrate, each of the first device 102 and the second device 104 may, based on the schedule 107, transition to (or remain in) the active operating mode during the first paging window to monitor the communication channel 113. The first device 102 may, in response to determining that there is data to be sent to the second device 104 during the first TB 111, send a traffic advertisement via the communication channel 113 during the first paging window. The second device 104 may receive the traffic advertisement during the first paging window. The first device 102 may send the data 117, via the communication channel 113 during a first data transmission window of the first TB 111, to the second device 104. The second device 104 may, in response to receiving the traffic advertisement during the first paging window and determining that the traffic advertisement indicates availability of data to be sent to the second device 104, monitor the communication channel 113 during the first data transmission window. The second device 104 may receive the data 117 via the communication channel 113 during the first data transmission window.

In a particular aspect, the first device 102 may send the no data indicator 119 of FIG. 1 via the communication channel 113 during the first paging window in response to determining that there is no data to send to the second device 104 during the first TB 111. The second device 104 may, in response to receiving the no data indicator 119 during the first paging window, transition to the second operating mode during a remaining portion of the first TB 111.

In a particular aspect, the first device 102 may send the no more data indicator 121 of FIG. 1 via the communication channel 113 during the first data transmission window, as described with reference to FIG. 1. The second device 104 may, in response to receiving the no more data indicator 121 during the first data transmission window, transition to the second operating mode during a remaining portion of the first TB 111. The second device 104 may, based on the schedule 107, transition to the active operating mode during a second paging window of the second TB 211 to monitor the communication channel 113 for traffic advertisements from the first device 102.

The system 200 may thus enable the first device 102 and the second device 104 to satisfy the target QoS 101 while conserving resources based on the schedule 107. For example, data transmissions (if any) during the time-blocks 109 may satisfy the target latency 103, the target data rate 105, or both. The first device 102, the second device 104, or both, may conserve resources by transitioning to the second operating mode when there is no data (or no more data) to be exchanged.

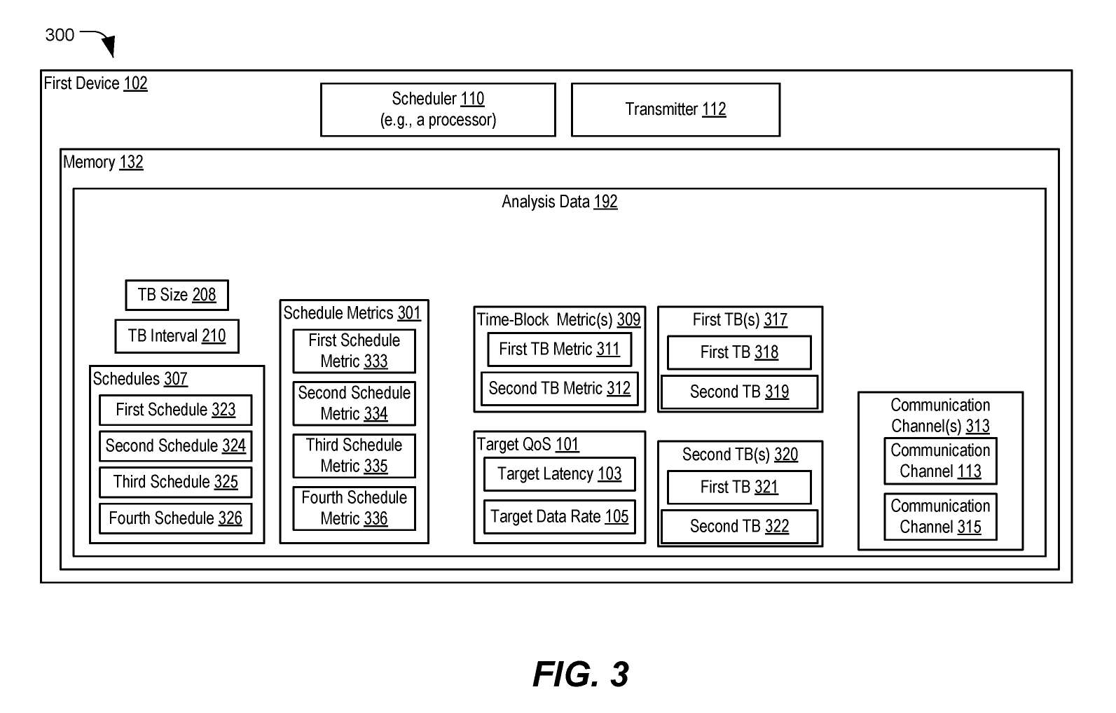

Referring to FIG. 3, a particular aspect of a system is disclosed and generally designated 300. The system 300 may correspond to the system 100 of FIG. 1. For example, the system 100 may include one or more components of the system 300.

During operation, the scheduler 110 may generate a plurality of schedules 307 and may select the schedule 107 from the schedules 307, as described herein. The plurality of schedules 307 may correspond to one or more communication channels 313. The communication channels 313 may include the communication channel 113, a communication channel 315, one or more additional communication channels, or a combination thereof.

The scheduler 110 may determine the TB size 208, the TB interval 210, or both, based on the target QoS 101, as described with reference to FIG. 2. The scheduler 110 may determine one or more time-blocks corresponding to the communication channels 313. For example, the scheduler 110 may, based on the TB size 208, the TB interval 210, or both, determine one or more first TBs 317 corresponding to the communication channel 113, one or more second TBs 320 corresponding to the communication channel 315, or both. The first TBs 317 may include a first TB 318, a second TB 319, one or more additional TBs, or a combination thereof. The second TBs 320 may include a first TB 321, a second TB 322, one or more additional TBs, or a combination thereof. Duration of each of the first TBs 317 and the second TBs 320 may correspond to the TB size 208. An interval between consecutive TBs of the first TBs 317 may correspond to the TB interval 210. An interval between consecutive TBs of the second TBs 320 may correspond to the TB interval 210.

The scheduler 110 may determine one or more time-block metrics 309 corresponding to the first TBs 317, the second TBs 320, or a combination thereof. For example, the scheduler 110 may determine a first TB metric 311 of the first TB 318, a second TB metric 312 of the first TB 321, or both. A time-block metric of a particular TB may be based on a predicted level of occupancy (α), a predicted level of concurrent operations (β), or both, on the corresponding communication channel during the TB. The scheduler 110 may determine the predicted level of occupancy (α) based on expected traffic of other NAN operations. For example, the scheduler 110 may determine the predicted level of occupancy (α) based on one or more schedules corresponding to other data link groups. In a particular aspect, the scheduler 110 may transmit a utilization query to other devices (e.g., the second device 104). For example, the transmitter 112 may transmit a broadcast subscription message including a utilization query. A particular device (e.g., the second device 104) may, in response to receiving the utilization query, send a schedule corresponding to a second data link group to the first device 102. The schedule may indicate whether the particular device (e.g., the second device 104) is participating in the second data link group as primarily a provider device or as primarily a subscriber device.

In a particular aspect, the particular device (e.g., the second device 104) may send the schedule responsive to the utilization query in response to determining that the particular device is participating in the second data link group as primarily a provider device. The particular device (e.g., the second device 104) may refrain from sending the schedule responsive to the utilization query in response to determining that the particular device is participating in the second data link group as primarily a subscriber device.

The scheduler 110 may determine the predicted level of occupancy (α) of a particular communication channel during a first TB based on the schedule corresponding to the second data link group. In a particular aspect, the schedule may not include any TBs associated with the particular communication channel that overlap the first TB. In this aspect, the scheduler 110 may determine that the predicted level of occupancy (α) of the particular communication channel during the first TB is independent of the second data link group. In an alternative aspect, the schedule may include at least one TB associated with the particular communication channel that at least partially overlaps the first TB. The scheduler 110 may, in response to determining that the schedule includes the at least one TB, determine that the second data link group is associated with the particular communication channel during the first TB. In this aspect, the scheduler 110 may determine the predicted level of occupancy (α) based on the overlapped portion of the first TB, a count of data link groups associated with the particular communication channel during the first TB, or both. For example, the predicted level of occupancy (α) may correspond to a ratio of a size (e.g., duration) of the overlapped portion of the first TB relative to a size (e.g., duration) of the first TB. As another example, the predicted level of occupancy (α) may correspond to a weighted ratio of the size (e.g., the duration) of the overlapped portion relative to the size (e.g., the duration) of the first TB, where the weight corresponds to a count of data link groups associated with the particular communication channel during the first TB.

The scheduler 110 may determine the overlapped portion based on multiple schedules. For example, a first schedule and a second schedule may indicate that a first data link group and a second data link group, respectively, are associated with the particular communication channel during the first TB. To illustrate, the first schedule may include at least one first TB associated with the particular communication channel that at least partially overlaps a first portion of the first TB. The second schedule may include at least one second TB associated with the particular communication channel that at least partially overlaps a second portion of the first TB. The overlapped portion may correspond to the first portion and the second portion.

The scheduler 110 may determine the predicted level of concurrent operations (β) based on expected traffic related to other networks. The other networks may include a Bluetooth® network (Bluetooth is a registered trademark of Bluetooth SIG, Inc. of Kirkland, Wash.), a Long-Term Evolution (LTE®) network (LTE is a registered trademark of Institut Européen des Normes of France), a LTE-U network, or another network. The communication channel 113 may be unavailable during a time period in which a device is expected to exchange data related to the other networks.

The scheduler 110 may determine the first TB metric 311 based on a predicted level of occupancy (α), a predicted level of concurrent operations (β), or both, of the communication channel 113 during the first TB 318. The scheduler 110 may determine the second TB metric 312 based on a predicted level of occupancy (α), a predicted level of concurrent operations (β), or both, of the communication channel 315 during the first TB 321. In a particular aspect, a time-block metric of a particular TB corresponding to a particular communication channel may be based on a preference of the first device 102 to monitor the particular communication channel during at least a portion of the particular TB to perform other operations. The other operations may include an infra operation (e.g., receive an AP beacon), an operation associated with a second data link group, or both.

The scheduler 110 may generate the schedules 307 based on various combinations of one or more time-blocks of the first TBs 317, the second TBs 320, or both. For example, a first schedule 323 of the schedules 307 may include the first TBs 317, a second schedule 324 of the schedules 307 may include the second TBs 320, a third schedule 325 of the schedules 307 may include a first combination of the first TBs 317 and the second TBs 320, a fourth schedule 326 of the schedules 307 may include a second combination of the first TBs 317 and the second TBs 320, and so on. In a particular aspect, the third schedule 325 may include the first TB 318 and the second TB 322, and the fourth schedule 326 may include the first TB 321 and the second TB 319.

In a particular aspect, the scheduler 110 may generate the schedules 307 such that each schedule corresponds to a single communication channel. For example, the scheduler 110 may generate the first schedule 323 that includes the first TBs 317 corresponding to the communication channel 113, the second schedule 324 that includes the second TBs 320 corresponding to the communication channel 315, or both. The schedules 307 may include the first schedule 323, the second schedule 324, or both. In this aspect, the scheduler 110 may refrain from generating a schedule that corresponds to multiple communication channels. For example, the scheduler 110 may refrain from generating the third schedule 325 including the first combination of the first TBs 317 and the second TBs 320. As another example, the scheduler 110 may refrain from generating the fourth schedule 326 including the second combination of the first TBs 317 and the second TBs 320. The third schedule 325 and the fourth schedule 326 may not be included in the schedules 307.

The scheduler 110 may determine schedule metrics 301 based on the schedules 307 and the time-block metrics 309. For example, the scheduler 110 may determine a first schedule metric 333 corresponding to the first schedule 323, a second schedule metric 334 corresponding to the second schedule 324, a third schedule metric 335 corresponding to the third schedule 325, a fourth schedule metric 336 corresponding to the fourth schedule 326, or a combination thereof.

A particular schedule metric may correspond to a sum of time-block metrics of corresponding time-blocks. The particular schedule metric may include channel switching costs if the corresponding time-blocks are associated with multiple communication channels. For example, the first schedule metric 333 may correspond to a sum of TB metrics of the first TBs 317, and the second schedule metric 334 may correspond to a sum of TB metrics of the second TBs 320. The third schedule metric 335 may correspond to a sum of TB metrics of the first combination of the first TBs 317 and the second TBs 320 and first channel switching costs. The first channel switching costs may be based on a first number of channel switches indicated by the first combination (e.g., first channel switching costs=channel switching cost*first number). The channel switching cost may be based on a detected channel switching delay, an average channel switching delay, a default value, or a combination thereof. The fourth schedule metric 336 may correspond to a sum of TB metrics of the second combination of the first TBs 317 and the second TBs 320 and second channel switching costs. The second channel switching costs may be based on a second number of channel switches indicated by the second combination.

The scheduler 110 may select a particular schedule metric (e.g., a lowest schedule metric) of the schedule metrics 301. The scheduler 110 may select a particular schedule of the schedules 307 that corresponds to the particular schedule metric. The particular schedule (e.g., the first schedule 323, the second schedule 324, the third schedule 325, or the fourth schedule 326) may correspond to the schedule 107 of FIG. 1.

The system 300 may thus enable selection of the schedule 107 from multiple schedules (e.g., the schedules 307). The selection of the schedule 107 may be based on time-block metrics corresponding to one or more communication channels. The time-block metrics may account for predicted occupancy, predicted concurrent operations, or both, on the corresponding communication channels.

Referring to FIG. 4, a system is shown and generally designated 400. The system 400 may correspond to the system 100 of FIG. 1. For example, the system 100 may include one or more components of the system 400. The first device 102 may include one or more memory buffers 402 (e.g., transmission buffers). The memory buffers 402 may be configured to store one or more packets 403 corresponding to data generated by the particular service. The transmitter 112 may be configured to transmit one or more of the packets 403 during data transmission windows corresponding to the schedule 107.

The memory buffers 402 may be configured to queue packets prior to transmission by the transmitter 112. For example, a first memory buffer of the memory buffers 402 may store a first packet of the packets 403 and a second packet of the packets 403. The first packet may be generated prior to the second packet. For example, the first packet may have a first timestamp that indicates a first time that is prior to a second time indicated by a second timestamp of the second packet. The transmitter 112 may be configured to transmit the first packet prior to transmitting the second packet. In a particular aspect, the first memory buffer may be configured to store unicast data to be transmitted to a particular device (e.g., the second device 104). A second memory buffer of the memory buffers 402 may be configured to store multicast (or broadcast) data to be transmitted to a particular set of devices. The particular set of devices may include the second device 104.

During operation, the scheduler 110 may determine whether to update the schedule 107 based on performance data 401, as described herein. Updating the schedule 107 may include moving communications to another communication channel, updating the delay margin 213, updating the TB size 208, updating the TB interval 210, or a combination thereof. The performance data 401 may include one or more of an injection rate (IR) 414, a first IR 415, a second IR 417, a drain rate 404, a first count 405, a second count 407, an average wait time 420, a sufficient TB interval count 422, a sufficient TB size count 418, or an inadequate TB count 416.

Updating the schedule 107 may include updating the delay margin 213. In a particular aspect, the scheduler 110 may update the delay margin 213 based on delays in accessing a transmission medium. The delays in accessing the transmission medium may be caused by channel switching time, medium occupancy due to other networks, or both. The scheduler 110 may determine an average delay 412 in accessing the transmission medium during time-blocks of a sample window. As referred to herein, a “sample epoch” may correspond to a sample window. The sample window may correspond to a number (e.g., 10) of discovery intervals, a number of discovery windows, a time interval, or a combination thereof. The scheduler 110 may determine a first average TB delay in accessing the transmission medium during the first TB 111 of FIG. 1, a second average TB delay in accessing the transmission medium during the second TB 211 of FIG. 2, and so on. The scheduler 110 may determine a particular average TB delay of a particular TB by querying underlying hardware (e.g., a media access controller) for medium access statistics at the end of the particular TB. The scheduler 110 may determine a first average discovery interval delay corresponding to the discovery interval 248 based on average TB delays of the time-blocks 109 of FIG. 1. For example, the scheduler 110 may determine the first average discovery interval delay based on an average of the first average TB delay, the second average TB delay, or both. The scheduler 110 may determine the average delay 412 based on average discovery interval delays of the discovery intervals during the sample window. For example, the scheduler 110 may determine the average delay 412 based on an average of the first average discovery interval delay corresponding to the discovery interval 248, a second average discovery interval delay corresponding to a second discovery interval, one or more additional average discovery intervals, or a combination thereof. The scheduler 110 may reset the average delay 412 during each sample window.

The scheduler 110 may determine whether to update the delay margin 213 based on a comparison of the average delay 412 and the delay margin 213. For example, the scheduler 110 may, in response to determining that the average delay 412 satisfies (e.g., is greater than or equal to) a delay threshold, update the delay margin 213 to correspond to the average delay 412. The scheduler 110 may update the TB interval 210 based on the updated delay margin 213, as described with reference to FIG. 2. Alternatively, the scheduler 110 may, in response to determining that the average delay 412 fails to satisfy (e.g., is less than) the delay threshold, refrain from updating the delay margin 213. The scheduler 110 may continue to use the delay margin 213 without updating until a next update period. The delay threshold may correspond to a particular percentage (e.g., 105%) of the delay margin 213. In a particular aspect, the scheduler 110 may, in response to determining that the average delay 412 satisfies (e.g., is greater than or equal to) a first threshold or that the average delay 412 satisfies (e.g., is less than or equal to) a second threshold, update the delay margin 213 to correspond to the average delay 412. The first threshold may correspond to a first percentage (e.g., 105%) of the delay margin 213 and the second threshold may correspond to a second percentage (e.g., 95%) of the delay margin 213. In a particular aspect, the scheduler 110 may update the delay margin 213 by attempting to move communications to another channel, as described herein. For example, the scheduler 110 may, in response to determining that communications may be moved to a communication channel 413, update the delay margin 213 to correspond to a delay margin of the communication channel 413, as described herein.

The scheduler 110 may determine whether to update the TB size 208, a communication channel corresponding to the schedule 107, or both. The communication channel may include the communication channel 113. In a particular aspect, the scheduler 110 may determine that the TB size 208 is adequate to satisfy the target QoS 101 in response to determining that the scheduler 110 transmits at least threshold number of packets stored in the memory buffers 402 at the end of a threshold number of time-blocks during a sample window. For example, the scheduler 110 may determine that the TB size 208 is adequate in response to determining that the scheduler 110 transmitted all of the packets stored in the memory buffers 402 at the end of a particular percentage (e.g., at least 90%) of the time-blocks during a sample window. The scheduler 110 may determine that the TB size 208 is inadequate in response to determining that the scheduler 110 transmitted fewer than all of the packets stored in the memory buffers 402 at the end of a particular percentage (e.g., at least 10%) of the time-blocks during a sample window.

In a particular aspect, the scheduler 110 may determine the inadequate TB count 416 of a sample window. The scheduler 110 may reset the inadequate TB count 416 at a beginning of the sample window. For example, the scheduler 110 may set the inadequate TB count 416 to a first value (e.g., 0) at the beginning of the sample window. The scheduler 110 may determine, at the beginning of the first TB 111, that a first set of the memory buffers 402 include at least one packet. The scheduler 110 may, at the beginning of the first TB 111, select a first subset of the first set. The scheduler 110 may determine that a first memory buffer is included in the first subset in response to determining that one or more packets stored in the first memory buffer correspond to unicast data to be sent to a particular device (e.g., the second device 104) and that an ACK responsive to a traffic advertisement has been received from the second device 104. The scheduler 110 may determine that a second memory buffer is included in the first subset in response to determining that the second memory buffer stores packets corresponding to multicast (or broadcast) data.

The scheduler 110 may, during the first TB 111, remove a particular memory buffer from the first subset in response to sending the no more data indicator 121 of FIG. 1 corresponding to the particular memory buffer. For example, the scheduler 110 may, in response to determining that the particular memory buffer is empty, send the no more data indicator 121. The no more data indicator 121 may indicate that the first device 102 has no more data (e.g., packets) to send corresponding to the particular memory buffer. In a particular aspect, the scheduler 110 may remove the particular memory buffer from the first subset in response to determining that the no more data indicator 121 has been sent during a first portion of the first TB 111. The first portion may be based on a TB size decrement value. For example, the first TB 111 may begin at a first start time and may end at a first end time. The first portion may begin at the first start time and may end at a second end time that is based on the TB size decrement value (e.g., the second end time=the first end time−the TB size decrement value). The first subset may track memory buffers for which the first portion (corresponding to an updated value of the TB size 208) would be inadequate. The scheduler 110 may thus determine whether to update the TB size 208 based on whether the first portion is adequate.

The scheduler 110 may, in response to determining that the first subset is non-empty at the end of the first TB 111, determine that the first TB 111 (e.g., the first portion) is inadequate and may update (e.g., increment) the inadequate TB count 416. Alternatively, the scheduler 110 may, in response to determining that the first subset is empty, determine that the first TB 111 (e.g., the first portion) is adequate.

In a particular aspect, the first device 102 may receive data from one or more second devices of the data link group during the first TB 111. The scheduler 110 may determine, at the beginning of the first TB 111, that at least one packet corresponding to each of a second set of memory buffers of the second devices is available to be sent to the first device 102 during the first TB 111. For example, the first device 102 may receive a traffic advertisement from a second device during a PW of the first TB 111. The scheduler 110 may, in response to determining that the traffic advertisement indicates availability of data to be sent by the second device to the first device 102, determine that a memory buffer of the second device includes at least one packet available to be sent to the first device 102 during the first TB 111. The scheduler 110 may remove a particular second memory buffer from the second subset in response to receiving a no more data indicator indicating that the second device has no more data (e.g., packets) to send corresponding to the particular second memory buffer. In a particular aspect, the scheduler 110 may remove the particular second memory buffer from the second subset in response to determining that the no more data indicator has been received during the first portion of the first TB 111. The second subset may track memory buffers for which the first portion (corresponding to an updated value of the TB size 208) would be inadequate. The scheduler 110 may thus determine whether to update the TB size 208 based on whether the first portion is adequate.

The scheduler 110 may, in response to determining that the first subset is non-empty, the second subset is non-empty, or both, determine that the first TB 111 (e.g., the first portion) is inadequate, and may update (e.g., increment) the inadequate TB count 416. Alternatively, the scheduler 110 may, in response to determining that the first subset is empty and the second subset is empty, determine that the first TB 111 (e.g., the first portion) is adequate.

The scheduler 110 may, at the end of the sample window, determine whether the TB size 208 is adequate based on the inadequate TB count 416. For example, the scheduler 110 may, in response to determining that the inadequate TB count 416 satisfies (e.g., is less than) an inadequate TB count threshold, determine that the TB size 208 is adequate. The inadequate TB count threshold may correspond to a particular percentage (e.g., 10%) of a count of TBs during the sample window. Alternatively, the scheduler 110 may, in response to determining that the inadequate TB count 416 fails to satisfy (e.g., is greater than or equal to) the inadequate TB count threshold, determine that the TB size 208 is inadequate.

The scheduler 110 may, in response to determining that the TB size 208 is adequate, update (e.g., increment) the sufficient TB size count 418. The sufficient TB size count 418 may track a count of preceding sample windows during which the TB size 208 has been found to be adequate. The scheduler 110 may, in response to determining that the sufficient TB size count 418 satisfies (e.g., is greater than or equal to) a sufficient TB threshold (e.g., 5), update (e.g., decrement) the TB size 208 by a particular value (e.g., a TB size decrement value, such as 16 TU). Alternatively, the scheduler 110, in response to determining that the TB size 208 is inadequate, update (e.g., increment) the TB size 208 by a particular value (e.g., a TB size increment value, such as 16 TU). The scheduler 110 may reset the sufficient TB size count 418 to a particular value (e.g., 0) in response to updating (e.g., incrementing or decrementing) the TB size 208.

In a particular aspect, the scheduler 110 may determine whether the TB size 208 is adequate based on the drain rate 404, as described herein. The scheduler 110 may determine the first count 405 indicating an average number of packets remaining in the memory buffers 402 at the end of a plurality of time-blocks corresponding to one or more discovery intervals. For example, the scheduler 110 may determine that the memory buffers 402 included a first number of packets at the end of the first TB 111 of the discovery interval 248, a second number of packets at the end of the second TB 211 of the discovery interval 248, a first particular number of packets at the end of a first TB of a second discovery interval, a second particular number of packets at the end of a second TB of the second discovery interval, and so on. The first count 405 may correspond to an average of the first number, the second number, the first particular number, the second particular number, or a combination thereof.

The scheduler 110 may track the drain rate 404 over a sliding window of discovery intervals. For example, the first count 405 may include an average number of packets remaining in the memory buffers 402 at the end of time-blocks corresponding to a first discovery interval and a second discovery interval. The scheduler 110 may determine the second count 407 indicating an average number of packets remaining in the memory buffers 402 at the end of time-blocks corresponding to the second discovery interval and a third discovery interval, and so on. The drain rate 404 may indicate an average queue length at the end of time-blocks.

The scheduler 110 may determine that the drain rate 404 is decreasing in response to determining that the second count 407 is less than the first count 405. The scheduler 110 may determine that the drain rate 404 is increasing in response to determining that the second count 407 is greater than the first count 405. The scheduler 110 may determine that the drain rate 404 is constant in response to determining that the second count 407 is equal to the first count 405. The scheduler 110 may determine that the drain rate 404 is positive in response to determining that the second count 407 is positive. The scheduler 110 may determine that the drain rate 404 is zero in response to determining that the second count 407 is equal to 0.

The scheduler 110 may, in response to determining that the drain rate 404 is decreasing, determine that the TB size 208 is adequate. A decreasing drain rate (e.g., the drain rate 404) may indicate that a number of remaining packets at the end of each time-block is decreasing over time and that channel conditions are favorable (e.g., low occupancy and few concurrent operations).

The scheduler 110 may, in response to determining that the drain rate 404 is zero, determine that the TB size 208 is more than adequate to meet the target QoS 101. A zero drain rate (e.g., the drain rate 404) may indicate that there are no remaining packets at the end of each time-block and that channel conditions are favorable (e.g., low occupancy and few concurrent operations). Resources may be conserved by reducing the TB size 208 if the TB size 208 is greater than the minimum time-block size.

In a particular aspect, the scheduler 110 may, in response to determining that the drain rate 404 is positive (e.g., greater than 0) and that the drain rate 404 is increasing or constant, determine that the TB size 208 is inadequate. A positive drain rate (e.g., the drain rate 404) that is constant may indicate that there are packets at the end of each time-block and that a number of remaining packets is constant over time. A positive drain rate (e.g., the drain rate 404) that is increasing may indicate that there are packets at the end of each time-block and that the number of remaining packets is increasing over time. The TB size 208 may be increased to enable more packets to be transmitted if the TB size 208 is less than the maximum time-block size. If the TB size 208 is equal to the maximum time-block size, another communication channel with more favorable channel conditions (e.g., lower occupancy, fewer concurrent operations, or both) may be selected.

The scheduler 110 may refrain from updating the TB size 208 in response to determining that the TB size 208 is adequate to meet the target QoS 101. For example, the scheduler 110 may, in response to determining that the TB size 208 is adequate, continue to use the TB size 208 without updating until a next update period. In a particular aspect, the scheduler 110 may refrain from updating the TB size 208 in response to determining that the TB size 208 is more than adequate to meet the target QoS 101. In an alternate aspect, the scheduler 110 may selectively update (e.g., decrease) the TB size 208 to conserve resources in response to determining that the TB size 208 is more than adequate to meet the target QoS 101. For example, the scheduler 110 may, in response to determining that the TB size 208 satisfies (e.g., is greater than) a threshold (e.g., a minimum time-block size), update (e.g., decrease) the TB size 208 by a particular value. The particular value may correspond to a default value (e.g., 16 TUs). In a particular aspect, the scheduler 110 may determine the particular value based on a detected change in data rate. As another example, the scheduler 110 may, in response to determining that the TB size 208 fails to satisfy (e.g., is less than or equal to) the threshold (e.g., the minimum time-block size), refrain from updating (e.g., decreasing) the TB size 208.

The scheduler 110 may selectively update (e.g., increase) the TB size 208 in response to determining that the TB size 208 is inadequate. For example, the scheduler 110 may, in response to determining that the TB size 208 satisfies (e.g., is less than) a threshold (e.g., a maximum time-block size), update (e.g., increase) the TB size 208 by a particular value (e.g., a TB size increment value). The particular value may correspond to a default value (e.g., 16 TUs). In a particular aspect, the scheduler 110 may determine the particular value based on a detected change in data rate. As another example, the scheduler 110 may, in response to determining that the TB size 208 fails to satisfy (e.g., is greater than or equal to) the threshold (e.g., the maximum time-block size), refrain from updating (e.g., increasing) the TB size 208.

The scheduler 110 may, in response to determining that the TB size 208 is adequate or is more than adequate, refrain from attempting to move communications to another channel. For example, the scheduler 110 may refrain from updating the schedule 107 to change one or more communication channels (e.g., the communication channel 113) corresponding to the time-blocks 109. Alternatively, the scheduler 110 may, in response to determining that the TB size 208 is inadequate, attempt to move communications to another channel, as described herein.

The scheduler 110 may determine whether to update the TB interval 210, a communication channel corresponding to the schedule 107, or both. The communication channel may include the communication channel 113. In a particular aspect, the scheduler 110 may determine that the TB interval 210 is adequate in response to determining that an average of longest wait times of packets in the memory buffers 402 during a sample window satisfies (e.g., is less than or equal to) a latency threshold. The latency threshold may be based on the target latency 103 of FIG. 1 (e.g., 105% of the target latency 103).

In a particular aspect, the scheduler 110 may determine whether the TB interval 210 is adequate based on the average wait time 420 (Q_{delay}), as described herein. The scheduler 110 may set (or reset) the average wait time 420 to a particular value (e.g., 0) at a beginning of a sample window. The scheduler 110 may, during a time-block (e.g., the first TB 111 of FIG. 1), determine a first wait time of a first packet in each of the memory buffers 402. The first packet of a particular memory buffer may correspond to, at a beginning of a time-block (e.g., the first TB 111), a next packet to be transmitted from the particular memory buffer. In a particular aspect, the first wait time of the first packet may correspond to a difference between a first queue time and a first transmit time. The first queue time may correspond to a time at which the first packet is added to the particular memory buffer and the first transmit time may correspond to a time at which the transmitter 112 transmits the first packet. In another aspect, the first wait time of the first packet may correspond to a difference between a particular transmit time of a particular packet and the first transmit time of the first packet. The first packet may be next to the particular packet in a sequence of packets and the particular transmit time may correspond to a time at which the transmitter 112 transmits the particular packet. The first packet may be prior to or subsequent to the particular packet in the sequence of packets.

The scheduler 110 may determine that a particular first packet of a particular memory buffer of the memory buffers 402 has a particular wait time (e.g., a longest wait time) during the first TB 111. For example, at a beginning of the first TB 111, a first particular packet in a first buffer of the memory buffers 402 may be next to be transmitted from the first buffer, a second particular packet in a second buffer of the memory buffers 402 may be next to be transmitted from the second buffer, or both. The transmitter 112 may transmit the first particular packet, the second particular packet, or both, during the first TB 111. The first particular packet may have a first wait time and the second particular packet may have a second wait time, as described above. The scheduler 110 may determine a first TB time corresponding to a particular time (e.g., a longest wait time) of the first wait time and the second wait time. For example, the scheduler 110 may determine the first TB time corresponding to the first wait time in response to determining that the first wait time is greater than or equal to the second wait time.

The scheduler 110 may determine the average wait time 420 based on TB times of time-blocks of the sample window. In a particular aspect, the sample window may include multiple discovery intervals. For example, the sample window may include the discovery interval 248 and a second discovery interval. The scheduler 110 may determine a first discovery interval wait time of the discovery interval 248 based on an average of the first TB time of the first TB 111, a second TB time of the second TB 211, and so on. The scheduler 110 may determine a second discovery interval wait time of a second discovery interval. The scheduler 110 may determine the average wait time 420 of the sample window based on an average of the first discovery interval wait time, the second discovery interval wait time, or both.

In a particular aspect, the scheduler 110 may disregard a TB time of a particular time-block in determination of the average wait time 420 in response to determining that the particular time-block is an outlier. The scheduler 110 may determine that the particular time-block is an outlier in response to determining that the particular time-block overlaps a time during which other traffic (e.g., a NAN beacon, an infrastructure beacon, or both) is exchanged. The scheduler 110 may determine that the particular time-block is an outlier in response to determining that the first device 102 sent a traffic advertisement during the particular time-block and that no message (e.g., an ACK or a data request) responsive to the traffic advertisement is received from the second device 104 during the particular time-block.

The scheduler 110 may determine that the TB interval 210 is adequate in response to determining that the average wait time 420 satisfies (e.g., is less than) a threshold interval. The threshold interval may correspond to a particular percentage (e.g., 105%) of the target latency 103. The scheduler 110 may, in response to determining that the average wait time 420 satisfies (e.g., is less than) a first threshold interval, update (e.g., increment) the sufficient TB interval count 422. The first threshold interval may be based on the target latency 103 (e.g., the first threshold interval=the target latency 103−16 TU). The sufficient TB interval count 422 may track a count of preceding sample windows during which the average wait time 420 satisfied the first threshold interval. The scheduler 110 may, in response to determining that the sufficient TB interval count 422 satisfies a threshold (e.g., 5), determine that the TB interval 210 is more than adequate. Alternatively, the scheduler 110 may determine that the TB interval 210 is inadequate in response to determining that the average wait time 420 fails to satisfy (e.g., is greater than or equal to) the threshold interval. The scheduler 110 may, in response to determining that the average wait time 420 fails to satisfy (e.g., is greater than or equal to) the threshold interval, set (or reset) the sufficient TB interval count 422 to a particular value (e.g., 0).

In a particular aspect, the scheduler 110 may determine whether the TB interval 210 is adequate based on the injection rate (IR) 414, as described herein. The scheduler 110 may determine the first IR 415 indicating an average number of packets added to the memory buffers 402 after the end of each time-block of a plurality of time-blocks and prior to the beginning of a next time-block of the plurality of time-blocks. The plurality of time-blocks may correspond to a first number (e.g., 10) of discovery intervals. For example, the scheduler 110 may determine that the memory buffers 402 included a first end number of packets at the end of the first TB 111 of the discovery interval 248, a second start number of packets at the beginning of the second TB 211 of the discovery interval 248, a second end number of packets at the end of the second TB 211, a third start number of packets at the beginning of a third TB of the discovery interval 248, and so on. The scheduler 110 may determine a first injection count based on a difference between the first end number and the second start number, a second injection count based on a difference between the second end number and the third start number, and so on.

The scheduler 110 may determine an injection rate corresponding to discovery interval based on an average of the injection counts corresponding to time-blocks of the discovery interval. For example, the scheduler 110 may determine a first injection rate corresponding to the discovery interval 248 based on an average of the first injection count and the second injection count.

The scheduler 110 may track an average injection rate over a sliding window of a number (e.g., 2) of discovery intervals. For example, the scheduler 110 may determine the first IR 415 based on an average of a first injection rate of a first discovery interval (e.g., the discovery interval 248) and a second injection rate of a second discovery interval. The scheduler 110 may determine the second IR 417 based on an average of the second injection rate of the second discovery interval and an injection rate of a third discovery interval. The second discovery interval may be subsequent to the first discovery interval and prior to the third discovery interval.

The scheduler 110 may determine a trend (e.g., increasing, decreasing, constant) corresponding to the injection rates based on the first IR 415, the second IR 417, one or more additional IRs, or a combination thereof. For example, the scheduler 110 may determine that the IR 414 is decreasing in response to determining that the second IR 417 is less than the first IR 415. The scheduler 110 may determine that the IR 414 is increasing in response to determining that the second IR 417 is greater than the first IR 415. The scheduler 110 may determine that the IR 414 is zero in response to determining that the second IR 417 has a particular value (e.g., 0). The scheduler 110 may determine that the IR 414 is positive in response to determining that the second IR 417 is greater than a particular value (e.g., 0).

The scheduler 110 may, in response to determining that the IR 414 decreasing, determine that the TB interval 210 is adequate. A decreasing IR (e.g., the IR 414) may indicate that a number of packets accumulated between time-blocks are decreasing and that channel conditions are favorable (e.g., low occupancy and few concurrent operations).

In a particular aspect, the scheduler 110 may, in response to determining that the IR 414 is zero, determine that the TB interval 210 is more than adequate. A zero IR (e.g., the IR 414) may indicate that there are no packets accumulated between time-blocks and that channel conditions are favorable (e.g., low occupancy and few concurrent operations). Resources may be conserved by increasing the TB interval 210 if the TB interval 210 is less than the maximum time-block interval.

In a particular aspect, the scheduler 110 may, in response to determining that the IR 414 is positive and that the IR 414 is constant or increased, determine that the TB interval 210 is inadequate. A positive and constant or increasing IR (e.g., the IR 414) may indicate that there are packets accumulated between time-blocks and that a number of packets accumulated between time-blocks are constant or increasing. The TB interval 210 may be reduced if the TB interval 210 is greater than the minimum time-block interval. If the TB interval 210 is equal to the minimum time-block interval and the TB size 208 is less than the maximum time-block size, the TB size 208 may be increased. If the TB size 208 is equal to the maximum time-block size, another communication channel having more favorable channel conditions (e.g., lower occupancy, fewer concurrent operations, or both) may be selected.

The scheduler 110 may, in response to determining that the TB interval 210 is adequate, refrain from updating the TB interval 210. For example, the scheduler 110 may, in response to determining that the TB interval 210 is adequate, continue to use the TB interval 210 without updating until a next update period. In a particular aspect, the scheduler 110 may, in response to determining that the TB interval 210 is more than adequate, refrain from updating the TB interval 210. For example, the scheduler 110 may, in response to determining that the TB interval 210 is more than adequate, continue to use the TB interval 210 without updating until a next update period. In an alternate aspect, the scheduler 110 may, in response to determining that the TB interval 210 is more than adequate, selectively update the TB interval 210 to conserve resources. For example, the scheduler 110 may, in response to determining that the TB interval 210 satisfies (e.g., is less than) a threshold (e.g., a maximum time-block interval), update (e.g., increase) the TB interval 210 by a particular value. The particular value may correspond to a default value (e.g., 16 TUs). In a particular aspect, the scheduler 110 may determine the particular value based on a detected change in data rate. As another example, the scheduler 110 may, in response to determining that the TB interval 210 fails to satisfy (e.g., is greater than or equal to) the threshold (e.g., the maximum time-block interval), refrain from updating (e.g., increasing) the TB interval 210. For example, the scheduler 110 may, in response to determining that the TB interval 210 fails to satisfy (e.g., is greater than or equal to) the threshold (e.g., the maximum time-block interval), continue to use the TB interval 210 without updating until a next update period.

The scheduler 110 may, in response to determining that the TB interval 210 is adequate or is more than adequate, refrain from attempting to move communications to another channel. For example, the scheduler 110 may refrain from updating the schedule 107 to change one or more communication channels (e.g., the communication channel 113) corresponding to the time-blocks 109. The scheduler 110 may, in response to determining that the TB interval 210 is adequate or is more than adequate, continue to use the communication channel 113 corresponding to the time-blocks 109 until a next update period.

The scheduler 110 may, in response to determining that the TB interval 210 is inadequate, selectively update the TB interval 210. For example, the scheduler 110 may, in response to determining that the TB interval 210 satisfies (e.g., is greater than) a threshold (e.g., a minimum time-block interval, such as 16 TU), update (e.g., decrease) the TB interval 210 by a particular value. The particular value may correspond to a default value (e.g., 16 TUs). In a particular aspect, the scheduler 110 may determine the particular value based on a detected change in data rate. As another example, the scheduler 110 may, in response to determining that the TB interval 210 fails to satisfy (e.g., is less than or equal to) the threshold (e.g., the minimum time-block interval), refrain from updating (e.g., decreasing) the TB interval 210. The scheduler 110 may, in response to determining that the TB interval 210 fails to satisfy (e.g., is less than or equal to) the threshold (e.g., the minimum time-block interval), continue to use the TB interval 210 without updating until a next update period. In a particular aspect, the scheduler 110 may, in response to determining that the TB interval 210 fails to satisfy (e.g., is less than or equal to) the threshold (e.g., the minimum time-block interval), selectively update the TB size 208. For example, the scheduler 110 may, in response to determining that the TB size 208 satisfies (e.g., is less than) a TB size threshold (e.g., a maximum time-block size), update (e.g., increase) the TB size 208 by a particular value.

In a particular aspect, the scheduler 110 may, in response to determining that the TB interval 210 fails to satisfy (e.g., is less than or equal to) the threshold (e.g., the minimum time-block interval), attempt to move communications to another channel, as described herein. In a particular aspect, the scheduler 110 may, in response to determining that the TB interval 210 fails to satisfy (e.g., is less than or equal to) the threshold (e.g., the minimum time-block interval) and that the TB size 208 fails to satisfy (e.g., is greater than or equal to) a TB size threshold (e.g., a maximum time-block size), attempt to move communications to another channel, as described herein.

In a particular aspect, the scheduler 110 may attempt to move communications to another channel for various reasons, as described herein. For example, the scheduler 110 may attempt to move communications to another channel in response to detecting an update of the target QoS 101, the TB size 208, the TB interval 210, or a combination thereof. As another example, the scheduler 110 may attempt to move communications to another channel in response to determining that the TB interval 210 is inadequate, the TB size 208 is inadequate, or both. The scheduler 110 may determine a channel unusability time of a communication channel (e.g., the communication channel 113) corresponding to at least one of the time-blocks 109, as described with reference to FIG. 2. The scheduler 110 may attempt to move communications to another channel based on the channel unusability time, as described herein.

In a particular aspect, the scheduler 110 may, in response to determining that the channel unusability time satisfies (e.g., is less than) a threshold (e.g., 30%), refrain from moving communications to another channel. For example, the scheduler 110 may, in response to determining that the channel unusability time satisfies (e.g., is less than) the threshold (e.g., 30%), continue to use the communication channel 113 until a next update period. Alternatively, the scheduler 110 may in response to determining that the channel unusability time fails to satisfy (e.g., is greater than or equal to) the threshold (e.g., 30%), attempt to move communications to another channel. In particular aspect, the scheduler 110 may attempt to move communications to another channel irrespective of whether the channel unusability time satisfies (e.g., is less than) the threshold (e.g., 30%). For example, the scheduler 110 may, irrespective of whether the channel unusability time satisfies the threshold (e.g., 30%), attempt to move communications to another channel that has a lower unusability time than the channel unusability time of the communication channel 113.

The scheduler 110 may perform channel scanning operations in an attempt to move communications to another channel, as further described with reference to FIG. 10. For example, the scheduler 110 may generate a channel scan request and may receive one or more channel scan reports, as further described with reference to FIG. 10. The scheduler 110 may perform channel scanning operations in response to detecting an update of the target QoS 101, the TB size 208, the TB interval 210, or a combination thereof. As another example, the scheduler 110 may perform channel scanning operations in response to determining that the TB interval 210 is inadequate, the TB size 208 is inadequate, or both. In a particular aspect, the scheduler 110 may, in response to determining that the TB interval 210 is inadequate, that the TB size 208 is inadequate, or both, determine a channel unusability time of a communication channel (e.g., the communication channel 113) corresponding to at least one of the time-blocks 109, as described with reference to FIG. 2. The scheduler 110 may, in response to determining that the channel unusability time fails to satisfy (e.g., is greater than or equal to) the threshold (e.g., 30%), perform channel scanning operations.

In a particular aspect, the scheduler 110 may generate a first schedule (e.g., the schedule 107) and may determine that a first TB size (e.g., the TB size 208) of the first schedule is inadequate. The scheduler 110 may, in response to determining that the first TB size is inadequate, generate a second schedule (e.g., the schedule 107) having a second TB size (e.g., the TB size 208). The second TB size may correspond to an updated (e.g., increased) version of the first TB size. The scheduler 110 may, in response to determining that the second TB size is inadequate, proactively perform channel scanning operations in preparation for a move to another communication channel. The scheduler 110 may generate a third schedule (e.g., the schedule 107) having a third TB size (e.g., the TB size 208). The third TB size may correspond to an updated (e.g., increased) version of the second TB size. The scheduler 110 may, in response to determining that the third TB size is inadequate, determine a channel unusability time of a communication channel (e.g., the communication channel 113) corresponding to the third schedule (e.g., the schedule 107). The scheduler 110 may perform attempt to move communications to another channel based on the channel scanning operations in response to determining that the channel unusability time fails to satisfy (e.g., is greater than or equal to) the threshold (e.g., 30%).

In a particular aspect, the channel scan request may indicate a particular number (e.g., 3) of candidate channels. The candidate channels may include the communication channel 413. The one or more channel scan reports may indicate unusability times corresponding to the candidate channels. In a particular aspect, the scheduler 110 may select the candidate channels based on channel use data received from an application (e.g., an operating system), another component of the first device 102, or both. For example, the scheduler 110 may, in response to determining that the channel use data indicates that a particular channel is being used to perform operations corresponding to another network during a particular time period, exclude (or include) the particular channel in the candidate channels. The other network may include a Bluetooth® network (Bluetooth is a registered trademark of Bluetooth SIG, Inc. of Kirkland, Wash.), a Long-Term Evolution (LTE®) network (LTE is a registered trademark of Institut Européen des Normes of France), a LTE-U network, or another network. In a particular aspect, the scheduler 110 may attempt to move communications to another communication channel in response to receiving the channel use data.

The scheduler 110 may select one of the candidate channels based on unusability times. For example, the scheduler 110 may select the communication channel 413 in response to determining that the unusability times indicate that the communication channel 413 has a particular unusability time (e.g., a lowest unusability time) among the candidate channels, that a second unusability time of a communication channel 413 satisfies (e.g., is less than or equal to) the threshold (e.g., 30%), that the second unusability time of the communication channel 413 is less than the unusability time of the communication channel 113, or a combination thereof.

The scheduler 110 may update the schedule 107 such that the one or more of the time-blocks 109 correspond to the selected candidate channel (e.g., the communication channel 413). The scheduler 110 may update the delay margin 213 to correspond to the communication channel 413. The scheduler 110 may determine the delay margin 213 based on the second unusability time, as described with reference to FIG. 2. The scheduler 110 may update the TB interval 210 based on the updated delay margin 213, as described with reference to FIG. 2. The scheduler 110 may reset the performance data 401. Resetting the performance data 401 may include setting one or more of the IR 414, the first IR 415, the second IR 417, the drain rate 404, the first count 405, the second count 407, the average wait time 420, the sufficient TB interval count 422, the sufficient TB size count 418, or the inadequate TB count 416 to corresponding default values (e.g., 0).

In a particular aspect, the scheduler 110 may update the schedule 107 in response to detecting an update of the target QoS 101. For example, the particular service (or application) associated with the schedule 107 may update the target QoS 101. The scheduler 110 may determine the schedule 107 based on the updated target QoS 101, as described with reference to FIG. 1.

The scheduler 110 may, in response to determining that the schedule 107 is updated, generate the first schedule advertisement 115. The first schedule advertisement 115 may indicate the schedule 107 (e.g., the updated schedule 107). In a particular aspect, the first schedule advertisement 115 may include an update indicator indicating that the schedule 107 corresponds to an updated schedule. The transmitter 112 may transmit the first schedule advertisement 115. In a particular aspect, the first schedule advertisement 115 may indicate a start time of the updated schedule. The scheduler 110 may retain a copy of the schedule 107 prior to updating the schedule 107. The transmitter 112 may continue to operate based on the retained copy of the schedule 107 prior to the start time and may operate based on the schedule 107 (e.g., the updated schedule 107) subsequent to the start time. The scheduler 110 may, in response to determining that the schedule 107 is not updated, continue to use the schedule 107 until a subsequent discovery interval.

In a particular aspect, the scheduler 110 may generate the first schedule advertisement 115 during the discovery window 204. Refraining from updating the schedule 107 may include generating the first schedule advertisement 115 to include an indicator that indicates that the schedule 107 is the same as previously advertised (e.g., not updated). For example, the scheduler 110 may, in response to determining that the schedule 107 has not been updated subsequent to transmission of a previous schedule advertisement, generate the first schedule advertisement 115 to include an indicator that indicates that the schedule 107 is the same as previously advertised (e.g., not updated). For example, the transmitter 112 may transmit a first schedule advertisement (e.g., the first schedule advertisement 115) during the discovery window 202 of FIG. 2. The first schedule advertisement may indicate a first schedule (e.g., the schedule 107). The scheduler 110 may generate a second schedule advertisement indicating a second schedule (e.g., the schedule 107). The scheduler 110 may, in response to determining that the first schedule has not been updated subsequent to transmission of the first schedule advertisement or that the first schedule is the same as the second schedule, generate the second schedule advertisement to include an indicator that indicates that the second schedule is the same as the previously advertised first schedule.

In FIG. 4, a timeline is also shown and generally designated 450. The timeline 450 may include a plurality of schedule advertisement windows. For example, the timeline 450 may include a schedule advertisement window 452, a schedule advertisement window 258, a schedule advertisement window 464, or a combination thereof. A schedule advertisement window may correspond to a discovery window.

The scheduler 110 may be configured to transmit the first schedule advertisement 115 during a schedule advertisement window. For example, the scheduler 110 may transmit, via the transmitter 112, a first schedule advertisement (e.g., the first schedule advertisement 115) during the schedule advertisement window 452. The schedule advertisement window 452 may begin at a time t1 and may end at a time t2. The schedule advertisement window 452 may include one or more discovery windows. For example, the schedule advertisement window 452 may include the DW 202 of FIG. 2. The first schedule advertisement 115 may indicate a schedule lifetime value. The schedule lifetime value may indicate a number of DWs (e.g., 20 DWs), a number of discovery intervals (e.g., 20 discovery intervals), a time interval (e.g., 10 seconds), or a combination thereof.

The schedule lifetime value may indicate a time that a first schedule (e.g., the schedule 107) indicated by the first schedule advertisement (e.g., the first schedule advertisement 115) is valid. For example, the scheduler 110 may determine that the first schedule (e.g., the schedule 107) indicated by the first schedule advertisement (e.g., the first schedule advertisement 115) is valid during a schedule window 456. The schedule window 456 may begin at the time t2 and may end at a time t4. The scheduler 110 may determine duration of the schedule window 456 based on the schedule lifetime value.

The schedule lifetime value may correspond to a default value, a configuration value, or both. In a particular aspect, the schedule lifetime value may be negotiated during data link setup. In a particular aspect, the first device 102 may provide the schedule lifetime value to the second device 104. For example, the first device 102 may indicate the schedule lifetime value in a service advertisement.

The schedule advertisement value may correspond to a default value, a configuration value, or both. In a particular aspect, the schedule advertisement value may be negotiated during data link setup. In a particular aspect, the first device 102 may provide the schedule advertisement value to the second device 104. For example, the first device 102 may indicate the schedule advertisement value in a service advertisement.

The scheduler 110 may determine that an update to the first schedule (e.g., the schedule 107) may be advertised during a schedule advertisement window 458 prior to the end of the schedule window 456. The scheduler 110 may determine duration of the schedule advertisement window 458 based on a schedule advertisement value. The first schedule advertisement (e.g., the first schedule advertisement 115) may indicate the schedule advertisement value. The schedule advertisement value may indicate a number of DWs (e.g., 5 DWs), a number of discovery intervals (e.g., 5 discovery intervals), a time interval (e.g., 2.5 seconds), or a combination thereof. The scheduler 110 may transmit a second schedule advertisement (e.g., the first schedule advertisement 115) indicating a second schedule (e.g., the schedule 107) during the schedule advertisement window 458.

In a particular aspect, the second schedule advertisement (e.g., the first schedule advertisement 115) may indicate that the second schedule (e.g., the schedule 107) is updated. In an alternate aspect, the second schedule advertisement (e.g., the first schedule advertisement 115) may indicate that the second schedule (e.g., the schedule 107) is not updated. The scheduler 110 may determine that the second schedule (e.g., the schedule 107) is valid during a schedule window 462 based on a schedule lifetime value.

The scheduler 110 may determine (or update) the performance data 401 corresponding to the first schedule (e.g., the schedule 107) during a sample window 454 of the schedule window 456. The sample window 454 may begin at the time t2 and may end at the time t3. The scheduler 110 may, at the time t2, set (or reset) the performance data 401. The scheduler 110 may update the performance data 401 during the sample window 454, as described above. The second schedule (e.g., the schedule 107) may be valid during the schedule window 462. The scheduler 110 may update the performance data 401 during a sample window 460. The sample window 460 may begin at the time t4 and may end at a time t5.

The scheduler 110 may reset a first subset of the performance data 401 at the beginning of each sample window. The scheduler 110 may reset the first subset at the beginning of the sample window 454 and the sample window 460 irrespective of whether the first schedule or the second schedule correspond to an updated schedule. The first subset may include the average wait time 420, the inadequate TB count 416, or both.

The scheduler 110 may reset a second subset of the performance data 401 at the beginning of a schedule window corresponding to an updated schedule. For example, the scheduler 110 may, in response to determining that the second schedule is an updated version of the first schedule, reset the second subset of the performance data 401 at the time t4. The scheduler 110 may thus track the second subset of the performance of the performance data 401 across schedule windows when the schedule 107 remains unchanged. The second subset may include the sufficient TB size count 418, the sufficient TB interval count 422, the IR 414, the drain rate 404, or a combination thereof.

In a particular aspect, the scheduler 110 may reset the sufficient TB size count 418 in response to determining that the update of the schedule 107 includes an update of the TB size 208, a move to another communication channel, or both. For example, in this aspect, an update of the TB interval 210 may not trigger a reset of the sufficient TB size count 418. To illustrate, the scheduler 110 may track the sufficient TB size count 418 across schedule windows when the TB size 208 and the communication channel (e.g., the communication channel 113) associated with the schedule 107 remain unchanged, irrespective of whether the TB interval 210 changes.

The system 400 may enable dynamic updating of the schedule 107 based on detected conditions. The schedule 107 may be adjusted to conserve resources while satisfying the target QoS 101 during changing network conditions. The updated schedule 107 may also conform more closely to the capabilities of the transmitter 112.

Referring to FIG. 5, a system is shown and generally designated 500. The system 500 may correspond to the system 100 of FIG. 1. For example, the system 100 may include one or more components of the system 500.

The scheduler 110 may determine multiple schedules (e.g., the schedules 307) that satisfy the target QoS 101, as described with reference to FIG. 3. The scheduler 110 may send, via the transmitter 112, a first schedule negotiation message 515 indicating one or more proposed schedules 517. The proposed schedules 517 may include one or more of the schedules 307 of FIG. 3. The proposed schedules 517 may include the schedule 107. In a particular aspect, the first schedule negotiation message 515 may correspond to a service advertisement, the first schedule advertisement 115, or both.

In a particular aspect, the first device 102 may receive a channel preference message 511 via the receiver 114 from the second device 104. The channel preference message 511 may indicate a channel preference 513 of the second device 104. For example, the channel preference 513 may indicate one or more communication channels and corresponding preference scores. To illustrate, the channel preference 513 may indicate the communication channel 113 of FIG. 1 and a first preference score, the communication channel 315 of FIG. 3 and a second preference score, or both. The scheduler 110 may determine the proposed schedules 517 based on the channel preference 513, as described herein.

In a particular aspect, the scheduler 110 may determine that the channel preference 513 indicates that the second device 104 has an absolute preference for a particular channel. For example, the scheduler 110 may, in response to determining that the first preference score satisfies (e.g., is equal to) an absolute preference threshold (e.g., 100), determine that second device 104 has an absolute preference for the communication channel 113.

The scheduler 110 may, in response to determining that the second device 104 has an absolute preference for a particular communication channel (e.g., the communication channel 113), determine the proposed schedules 517 corresponding to the particular communication channel. For example, the scheduler 110 may, in response to determining that the second device 104 has an absolute preference for the communication channel 113, determine the first schedule 323 corresponding to the communication channel 113, as described with reference to FIG. 3. The scheduler 110 may also determine a schedule metric (e.g., the first schedule metric 333 of FIG. 3) of the particular communication channel (e.g., the communication channel 113). The scheduler 110 may, in response to determining that the first schedule metric 333 satisfies (e.g., is less than or equal to) a schedule threshold, generate the proposed schedules 517 to include the first schedule 323. The first schedule 323 may correspond to the schedule 107 of FIG. 1. Alternatively, the scheduler 110 may, in response to determining that the first schedule metric 333 fails to satisfy (e.g., is greater than) the schedule threshold, determine that the second device 104 is unavailable to participate in the data link group.

In a particular aspect, the scheduler 110 may determine that the channel preference 513 indicates that the second device 104 does not have an absolute preference for any communication channel. For example, the scheduler 110 may, in response to determining that each preference score indicated by the channel preference 513 fails to satisfy (e.g., is less than or equal to) the absolute preference threshold (e.g., 100), determine that the second device 104 has not indicated an absolute preference for any communication channel. In a particular aspect, the scheduler 110 may, in response to determining that the second device 104 has not indicated an absolute preference for any communication channel, disregard the channel preference 513 in determining the proposed schedules 517.

In a particular aspect, the scheduler 110 may determine that the channel preference 513 indicates that the second device 104 has a flexible preference for multiple communication channels and has a higher preference for one communication channel than another communication channel of the multiple communication channels. For example, the scheduler 110 may, in response to determining that each of the first preference score and the second preference score satisfies a flexible preference threshold (e.g., is greater than 0 and less than 100), determine that the channel preference 513 indicates that the second device 104 has a flexible preference for the communication channel 113 and the communication channel 315. The scheduler 110 may, in response to determining that the second preference score is higher than the first preference score, determine that the second device 104 has a higher preference for the communication channel 315 than the communication channel 113.

The scheduler 110 may process the communication channels indicated by the channel preference 513 in order of preference. For example, the scheduler 110 may order the communication channels indicated by the channel preference 513 by preference as indicated by the corresponding preference scores. The scheduler 110 may analyze a particular communication channel (e.g., the communication channel 315) corresponding to a particular preference score (e.g., a highest preference score). The scheduler 110 may generate a schedule (e.g., the second schedule 324) corresponding to the communication channel 315. The scheduler 110 may, in response to determining that the second schedule metric 334 satisfies the schedule threshold, add the second schedule 324 to the proposed schedules 517. Alternatively, the scheduler 110 may, in response to determining that the second schedule metric 334 fails to satisfy the schedule threshold, generate one or more schedules (e.g., the third schedule 325, the fourth schedule 326, or both) corresponding to the particular communication channel (e.g., the communication channel 315) and a next preferred communication channel (e.g., the communication channel 113). The scheduler 110 may, in response to determining that at least one of the third schedule metric 335 or the fourth schedule metric 336 satisfies the schedule threshold, add the corresponding schedule to the proposed schedules 517.

The scheduler 110 may, in response to determining that each of the third schedule metric 335 and the fourth schedule metric 336 fails to satisfy the schedule metric, generate a schedule (e.g., the first schedule 323) corresponding to a next preferred communication channel (e.g., the communication channel 113). The scheduler 110 may, in response to determining that the first schedule metric 333 satisfies the schedule threshold, add the first schedule 323 to the proposed schedules 517. The first schedule 323 may correspond to the schedule 107 of FIG. 1. The scheduler 110 may, in response to determining that the first schedule metric 333 fails to satisfy the schedule threshold, determine that the second device 104 is unavailable to participate in the data link group.

The second device 104 may, in response to receiving the first schedule negotiation message 515, determine schedule metrics corresponding to the proposed schedules 517, and may select the schedule 107 based on the schedule metrics, as described with reference to FIG. 3. For example, the second device 104 may determine the schedule metrics based on a predicted level of occupancy (α), a predicted level of concurrent operations (β), or both, of communication channels indicated by the proposed schedules 517 during the time-blocks of the proposed schedules 517, as described with reference to FIG. 3. The schedule metrics determined by the second device 104 may differ from first schedule metrics determined by the first device 102 for the proposed schedules 517 because the second device 104 may predict a different level of occupancy (α), a different level of concurrent operations (β), or both, than predicted by the first device 102.

The second device 104 may select the schedule 107 from the proposed schedules 517 in response to determining that the schedule 107 corresponds to a particular schedule metric (e.g., a highest schedule metric or a lowest schedule metric) of the schedule metrics. The second device 104 may send a second schedule negotiation message 519 to the first device 102. The second schedule negotiation message 519 may indicate a selection of the schedule 107. In a particular aspect, the second schedule negotiation message 519 may correspond to a subscription message.

In a particular aspect, the first schedule negotiation message 515 may indicate a preference corresponding to each of the proposed schedules 517. For example, the first schedule negotiation message 515 may indicate a first preference score corresponding to the schedule 107, a second preference score corresponding to a second schedule of the proposed schedules 517, and so on. In a particular aspect, the preference scores may correspond to schedule metrics. For example, the scheduler 110 may determine first schedule metrics corresponding to the proposed schedules 517, as described with reference to FIG. 3. The scheduler 110 may determine the first preference score based on a first schedule metric of the schedule 107, the second preference score based on a second schedule metric of the second schedule, and so on.

The second device 104 may select one of the proposed schedules 517 based on the corresponding schedule metrics, corresponding preference scores, or both. For example, the second device 104 may identify a subset of the proposed schedules 517 such that each schedule of the subset has a corresponding schedule metric that satisfies (e.g., is greater than) a threshold (e.g., a minimum schedule metric). The second device 104 may, in response to determining that the subset is empty, send a message indicating that the second device 104 is unavailable to participate in the data link group based on any of the proposed schedules 517, refrain from sending the second schedule negotiation message 519, or both. Alternatively, the second device 104 may, in response to determining that the subset includes a single schedule (e.g., the schedule 107), send the second schedule negotiation message 519 indicating the schedule 107.

In a particular aspect, the second device 104 may determine that the subset includes multiple schedules. For example, a first particular schedule metric may correspond to the schedule 107, a second particular schedule metric may correspond to the second schedule, a third particular schedule metric may correspond to a third schedule of the proposed schedules 517, and a fourth particular schedule metric may correspond to a fourth schedule of the proposed schedules 517. The second device 104 may, in response to determining that each of the first particular schedule metric, the second particular schedule metric, and the third particular schedule metric satisfies a schedule metric threshold (e.g., a minimum schedule metric), determine that the subset includes the schedule 107, the second schedule, and the third schedule.

The second device 104 may, in response to determining that the subset includes multiple schedules, determine preference scores corresponding to the subset based on the first schedule negotiation message 515. For example, the first schedule negotiation message 515 may indicate that a first preference score corresponds to the schedule 107, a second preference score corresponds to the second schedule, and a third preference score corresponds to the third schedule. The second device 104 may identify a particular preference score (e.g., a highest preference score) of the preference scores. For example, the particular preference score may indicate a highest preference for a corresponding schedule (e.g., the schedule 107) among the subset. To illustrate, the first preference score may indicate a higher preference than a second preference indicated by the second preference score, and a third preference indicated by the third preference score. The second device 104 may send the second schedule negotiation message 519 indicating the schedule 107 having the preference score indicating the higher preference.

In a particular aspect, multiple preference scores may indicate a highest preference. For example, the first preference score may be the same as the second preference score, and may indicate a higher preference than the third preference. The second device 104 may select a schedule (e.g., the schedule 107) from the schedules indicating the highest preference based on the corresponding schedule metrics. For example, the second device 104 may select the schedule 107 based on the first schedule metric and the second schedule metric. To illustrate, the second device 104 may select the schedule 107 in response to determining that the first particular schedule metric is greater than or equal to (or less than or equal to) the second particular schedule metric. The second device 104 may send the second schedule negotiation message 519 indicating the schedule 107.

The first device 102 may receive, via the receiver 114, the second schedule negotiation message 519. The scheduler 110 may, in response to receiving the second schedule negotiation message 519, determine that the second device 104 is available to participate in the data link group during at least some of the time-blocks 109 of FIG. 1 indicated by the schedule 107.

The system 500 may enable the first device 102 to negotiate with the second device 104 to determine the schedule 107. The schedule 107 may be based on preferences (e.g., schedule metrics) of the first device 102 and of the second device 104.

Referring to FIG. 6, a system is shown and generally designated 600. The system 600 may correspond to the system 100 of FIG. 1. For example, the system 100 may include one or more components of the system 600.

During operation, the receiver 114 may receive a schedule negotiation message 615 from the second device 104. In a particular aspect, the schedule negotiation message 615 may include the second schedule advertisement 125 of FIG. 1. The schedule negotiation message 615 may indicate a set of schedules 617 (e.g., proposed schedules). The schedules 617 may include one or more schedules. For example, the schedules 617 may include the second schedule 127. In a particular aspect, the second device 104 may send the schedule negotiation message 615 in response to receiving the first schedule negotiation message 515 of FIG. 5. For example, the second device 104 may determine the schedules 617 based on the proposed schedules 517 of FIG. 5. In a particular aspect, the schedule negotiation message 615 may correspond to a subscription message.

The scheduler 110 may determine that a subset of schedules 607 of the set of schedules 617 satisfy the target QoS 101. For example, a particular TB size, a particular TB interval, or both, may correspond to a particular schedule of the set of schedules 617. The scheduler 110 may determine that the subset of schedules 607 includes the particular schedule in response to determining that the particular TB size is greater than or equal to the TB size 208 of FIG. 2, that the particular TB interval is less than or equal to the TB interval 210 of FIG. 2, or both. For example, the subset of schedules 607 may include a first schedule, a second schedule, or a combination thereof.

The scheduler 110 may determine schedule metrics 601 corresponding to the subset of schedules 607, as described with reference to FIG. 3. For example, the scheduler 110 may determine a first schedule metric corresponding to the first schedule, a second schedule metric corresponding to the second schedule, or a combination thereof.

The scheduler 110 may determine whether any of the schedule metrics 601 satisfy a metric threshold 619 (e.g., a minimum schedule metric or a maximum schedule metric). The scheduler 110 may, in response to determining that a single schedule metric of the schedule metrics 601 satisfies the metric threshold 619, determine a corresponding schedule (e.g., the schedule 107) of the subset of schedules 607. The first device 102 may send the first schedule advertisement 115 indicating the schedule 107 corresponding to the single schedule metric that satisfies the metric threshold 619.

Alternatively, the scheduler 110 may, in response to determining that multiple schedule metrics of the schedule metrics 601 satisfy the metric threshold 619, select a particular schedule metric (e.g., a highest schedule metric or a lowest schedule metric) of the schedule metrics 601. The scheduler 110 may select a particular schedule (e.g., the schedule 107) corresponding to the particular schedule metric. The first device 102 may send the first schedule advertisement 115 indicating the schedule 107.

In a particular aspect, the scheduler 110 may determine that the subset of schedules 607 is empty or that none of the schedule metrics 601 satisfy the metric threshold 619. The scheduler 110 may generate one or more schedules 609 based on the target QoS 101, an availability of the second device 104 as indicated by the schedule negotiation message 615, or both, as described herein.

The scheduler 110 may determine channel availability 611 of the second device 104 based on the set of schedules 617. For example, the scheduler 110 may identify a set of communication channels indicated by the set of schedules 617. The scheduler 110 may identify a particular set of time-blocks corresponding to each communication channel based on the set of schedules 617. For example, a first schedule of the set of schedules 617 may indicate a first time-block corresponding to the communication channel 113 of FIG. 1, and a second schedule of the set of schedules 617 may indicate a second time-block corresponding to the communication channel 113. The first schedule may be the same as or distinct from the second schedule. The channel availability 611 may indicate that the second device 104 is available to communicate via the communication channel 113 during at least the first time-block and the second time-block. In a particular aspect, the channel availability 611 may indicate that the second device 104 is available to communicate via one or more additional communication channels during corresponding time-blocks.

The scheduler 110 may determine the schedules 609 based on the channel availability 611 and the target QoS 101. For example, the scheduler 110 may determine particular time-blocks from the channel availability 611 that are greater than or equal to the TB size 208 of FIG. 2. The scheduler 110 may generate the schedules 609 by selecting various combinations of the particular time-blocks such that the TB interval between consecutive time-blocks is less than or equal to the TB interval 210 of FIG. 2.

The scheduler 110 may determine first schedule metrics 613 corresponding to the schedules 609, as described with reference to FIG. 3. The scheduler 110 may determine a particular schedule metric (e.g., a highest schedule metric or a lowest schedule metric) of the first schedule metrics 613. The scheduler 110 may determine a particular schedule (e.g., the schedule 107) corresponding to the particular schedule metric. The first device 102 may send the first schedule advertisement 115 indicating the schedule 107.

The system 600 may thus enable a subscriber device (e.g., the second device 104) to propose one or more schedules to a provider device (e.g., the first device 102). The first device 102 may select one of the proposed schedules or may generate a schedule based on an availability of the second device 104 as indicated by the proposed schedules.

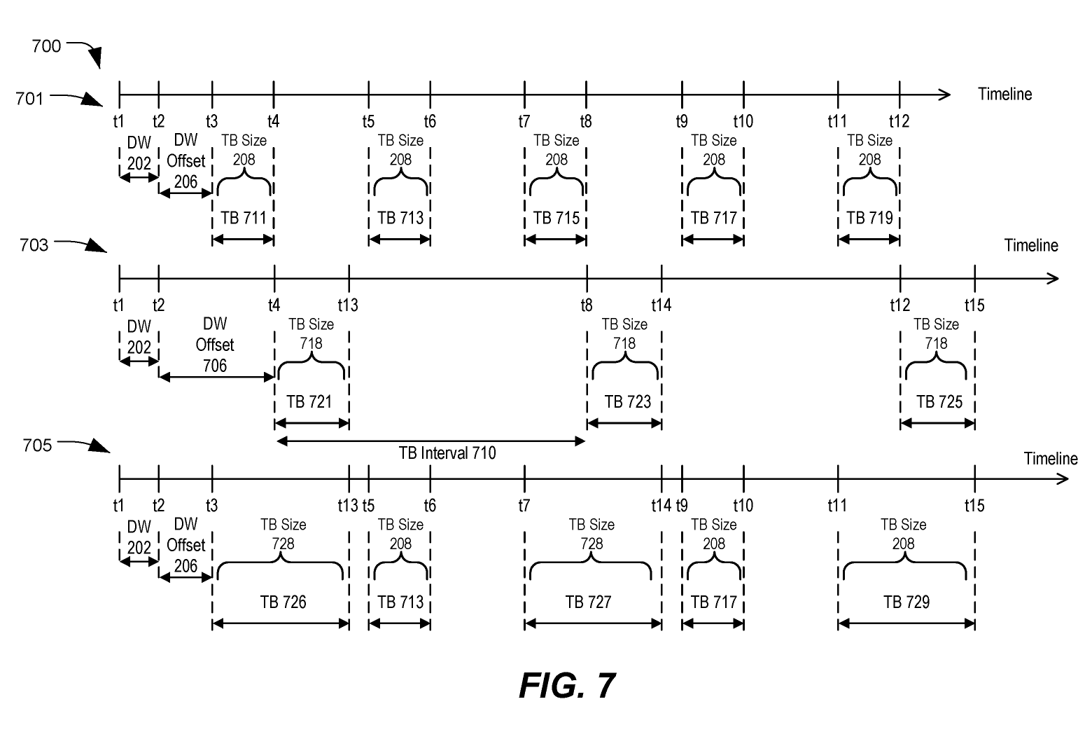

Referring to FIG. 7, a diagram of timelines is shown and generally designated 700. The timelines 700 include a first timeline 701, a second timeline 703, and a third timeline 705. The first timeline 701 may correspond to the schedule 107 associated with a first service. The second timeline 703 may correspond to a second schedule associated with a second service. The third timeline 705 may correspond to a combined schedule associated with the first service and the second service.

During operation, the first device 102 may provide multiple services (e.g., the first service and the second service). The first service may have a target QoS 101, and the second service may have a second target QoS. The scheduler 110 may determine the schedule 107 corresponding to the first service based on the target QoS 101, as described with reference to FIG. 1. For example, the scheduler 110 may determine that the TB size 208 and the TB interval 210 satisfy the target QoS 101. The schedule 107 may include first time-blocks corresponding to the TB size 208 and the TB interval 210. For example, the first time-blocks may include a TB 711, a TB 713, a TB 715, a TB 717, a TB 719, or a combination thereof.

The scheduler 110 may determine the second schedule corresponding to the second service based on the second target QoS, as described with reference to FIG. 1. For example, the scheduler 110 may determine that a TB size 728 and a TB interval 710 satisfy the second target QoS. The second schedule may include second time-blocks corresponding to the TB size 728 and the TB interval 710. For example, the second time-blocks may include a TB 721, a TB 723, a TB 725, or a combination thereof.

In a particular aspect, the scheduler 110 may determine a DW offset 706 to reduce (e.g., eliminate) overlap between the first time-blocks and the second time-blocks of the second schedule. For example, the scheduler 110 may, in response to determining that the TB size 718 is less than a difference between the TB interval 210 and the TB size 208, determine the DW offset 706 to reduce (e.g., eliminate) overlap between the first time-blocks and the second time-blocks.

The DW 202 may begin at a time t1 and end at a time t2. The DW offset 206 may begin at the time t2 and end at a time t3. The TB 711 may begin at the time t3 and end at a time t4. The TB 713 may begin at a time t5 and end at a time t6. The TB 715 may begin at a time t7 and end at a time t8. The TB 717 may begin at a time t9 and end at a time t10. The TB 719 may begin at a time t11 and end at a time t12. The scheduler 110 may determine the DW offset 706 based on a sum of the DW offset 206 and the TB size 208. For example, the DW offset 706 may begin at the time t2 and end at (or after) the time t4. The TB 721 may begin at (or after) the time t4 and end at a time t13. The time t13 may be at or prior to the time t5. The TB 723 may begin at (or after) the time t8 and end at a time t14. The time t14 may be at or prior to the time t9. The TB 725 may begin at (or after) the time t12 and end at a time t15.

The scheduler 110 may transmit, via the transmitter 112, the schedule 107 indicating the TB size 208, the TB interval 210, the DW offset 206, or a combination thereof. The scheduler 110 may transmit, via the transmitter 112, the second schedule indicating the TB size 718, the TB interval 710, the DW offset 706, or a combination thereof.

In an alternate aspect, the scheduler 110 may generate the third schedule by aggregating the first schedule and the second schedule. The scheduler 110 may shift the second time-blocks to align the TB 721 with the TB 711. The scheduler 110 may, in response to determining that a first time-block (e.g., the TB 711) of the first time-blocks overlaps a second time-block (e.g., the TB 721), generate a TB 726 having a TB size 728 that corresponds to a sum of the TB size 208 and the TB size 718.

The scheduler 110 may generate the third schedule indicating the DW offset 206, the TB size 728, the TB size 208, the TB interval 210, or a combination thereof. The scheduler 110 may determine the TB size 728 based on a sum of the TB size 208 and the TB size 718. The scheduler 110 may include the TB size 208 in the third schedule in response to determining that, subsequent to shifting the second time-blocks, at least one time-block (e.g., the TB 713) of the first time-blocks does not overlap any time-block of the second time-blocks. The third schedule may indicate that time-blocks alternate between having the TB size 728 and having the TB size 208. The scheduler 110 may include the DW offset 206 in the third schedule in response to determining that the DW offset 206 is less than or equal to the DW offset 706. The scheduler 110 may include the TB interval 210 in the third schedule in response to determining that the TB interval 210 is less than or equal to the TB interval 710.

The timelines 700 indicate various ways that the scheduler 110 may support multiple services. For example, the scheduler 110 may generate non-overlapping schedules (e.g., the first schedule and the second schedule) corresponding to a plurality of services. As another example, the scheduler 110 may generate a schedule (e.g., the third schedule) corresponding to multiple services and having time-blocks with non-uniform sizes.

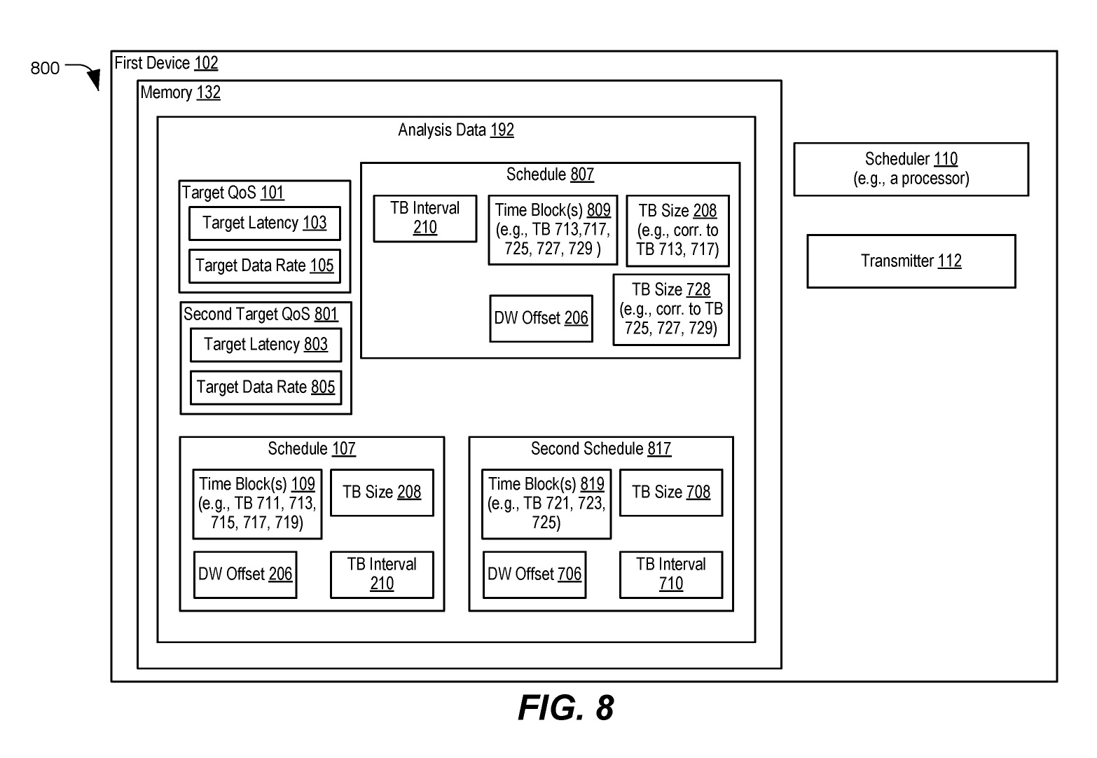

Referring to FIG. 8, a system is shown and generally designated 800. The system 800 may correspond to the system 100 of FIG. 1. For example, the system 100 may include one or more components of the system 800.

A first service may have the target QoS 101, and a second service may have a second target QoS 801. The second target QoS 801 may include target latency 803, a target data rate 805, or both. The scheduler 110 may generate a second schedule 817 based on the second target QoS 801, as described with reference to FIG. 1. The second schedule 817 may include the TB size 718, the TB interval 710, the DW offset 706, or a combination thereof. The second schedule 817 may indicate one or more time-blocks 819 corresponding to the TB size 718, the TB interval 710, the DW offset 706, or a combination thereof. For example, the time-blocks 819 may include the TB 721, the TB 723, the TB 725, or a combination thereof. The scheduler 110 may transmit, via the transmitter 112, the first schedule advertisement 115 indicating the schedule 107, a second schedule advertisement indicating the second schedule 817, or both.

In a particular aspect, the scheduler 110 may generate a schedule 807 by aggregating the schedule 107 and the second schedule 817, as described with reference to FIG. 7. The schedule 807 may include the DW offset 206, the TB interval 210, the TB size 208, the TB size 728, or a combination thereof. The schedule 807 may indicate one or more time-blocks 809. For example, the time-blocks 809 may include the TB 713, the TB 717, the TB 726, the TB 727, the TB 729, or a combination thereof. The schedule 807 may indicate that alternate time-blocks of the time-blocks 809 correspond to the TB size 208 and the TB size 728. For example, the TB 726, the TB 727, and the TB 729 may correspond to the TB size 728. The TB 713 and the TB 717 may correspond to the TB size 208.

The system 800 may enable the scheduler 110 to support multiple services. For example, the scheduler 110 may generate non-overlapping schedules (e.g., the first schedule and the second schedule) corresponding to a plurality of services. As another example, the scheduler 110 may generate a schedule (e.g., the third schedule) corresponding to multiple services and having time-blocks with non-uniform sizes.

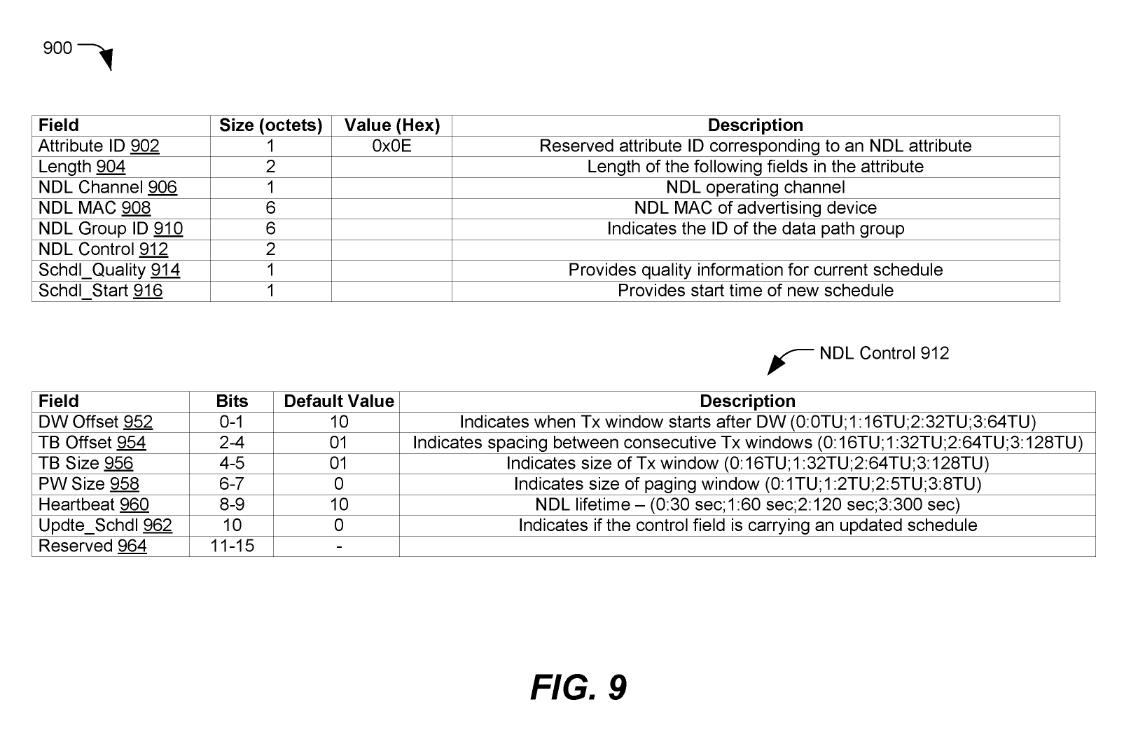

Referring to FIG. 9, a neighbor aware network (NAN) data link (NDL) attribute is shown and generally designated 900. The NDL attribute 900 may correspond to the first schedule advertisement 115 of FIG. 1. For example, the first schedule advertisement 115 may correspond to a SDF that includes the NDL attribute 900.

The NDL attribute 900 may include an attribute identifier (ID) field 902, a length field 904, an NDL channel field 906, an NDL MAC field 908, an NDL group ID field 910, an NDL control field 912, a schedule quality (schdl_quality) field 914, a schedule start (schdl_start) field 916, or a combination thereof. The NDL control field 912 may include a DW offset field 952, a TB offset field 954, a TB size field 956, a PW size field 958, a heartbeat field 960, an update schedule (updte_schdl) field 962, a reserved field 964, or a combination thereof.

During operation, the scheduler 110 may set the attribute ID field 902 to a particular value (e.g., 0x0E) to indicate that the NDL attribute 900 corresponds to a schedule advertisement. In a particular aspect, the particular value of the attribute ID field 902 may identify the corresponding attribute (e.g., the NDL attribute 900) as an NDL attribute. The length field 904 may indicate a length of the NDL attribute 900. The NDL channel field 906 may indicate the NAN communication channel. The NDL MAC field 908 may indicate an identifier (e.g., a MAC address) of the first device 102. The NDL group ID field 910 may indicate a data link identifier of the data link group.

The DW offset field 952 may indicate the DW offset 206. The TB offset field 954 may indicate the TB interval 210. The TB size field 956 may indicate the TB size 208. The PW size field 958 may indicate a size of a paging window of a time-block of the time-blocks 109. The heartbeat field 960 may indicate a lifetime of the data link group. For example, the heartbeat field 960 may indicate a duration that the data link group remains active subsequent to a most recent service advertisement (or schedule advertisement).

The scheduler 110 may set the updte_schdl field 962 to a first value (e.g., 0) in response to determining that the schedule 107 corresponds to a new schedule or that the schedule 107 is the same as previously advertised. Alternatively, the scheduler 110 may set the updte_schdl field 962 to a second value (e.g., 1) in response to determining that the schedule 107 is updated, as described with reference to FIG. 4. The scheduler 110 may retain a copy of the schedule 107 prior to updating the schedule 107. The schdl_start field 916 may indicate a start time of the updated schedule 107. For example, the schdl_start field 916 may indicate a number (e.g., 5) of DWs, a number (e.g., 5) of DW intervals, a time interval, or a combination thereof, after which the updated schedule 107 goes into effect. The copy of the schedule 107 may remain in effect prior to expiration of the number of DWs, the number of DW intervals, or the time interval indicated by the schdl_start field 916. For example, the scheduler 110 may transmit the first schedule advertisement 115 during the schedule advertisement window 458 of FIG. 4. The schdl_start field 916 may indicate duration of the schedule advertisement window 458. The copy of the schedule 107 may remain in effect during the schedule advertisement window 458 prior to the schedule window 462.

The schdl_quality field 914 may indicate quality information (e.g., a schedule metric) corresponding to the copy of the schedule 107. In a particular aspect, the scheduler 110 may determine the schdl_quality field 914 based on a drain rate, an IR, a delay margin, or a combination thereof. For example, the scheduler 110 may determine the delay margin 213, as described with reference to FIG. 2. The scheduler 110 may determine the IR 414, the drain rate 404, or both, as described with reference to FIG. 4. The schdl_quality field 914 may correspond to a sum of the delay margin 213, the IR 414, the drain rate 404, or a combination thereof. A higher value of the schdl_quality field 914 may indicate a lower capability of the copy of the schedule 107 to satisfy the target QoS 101.

In a particular aspect, the schdl_quality field 914 may indicate quality information (e.g., a schedule metric) of the updated schedule 107. The scheduler 110 may determine a value of the schdl_quality field 914 based on the following Table:

| TB Size 208 | | | | | TB Interval 210 | | | Channel | |
|---|---|---|---|---|---|---|---|---|---|
| | No | | Delay Margin 213 | | | No | | Change | |
| Increase | Change | Decrease | Increase | Decrease | Increase | Change | Decrease | Yes | No |
| Inadequate | 5 | 1 | 2 | 1 | 1 | 5 | 10 | 100 | 0 |
| TB count 416 | | | | | | | | | |

For example, the scheduler 110 may determine a set of weights corresponding to whether the updated schedule 107 indicates an increase in the TB size 208, no change in the TB size 208, a decrease in the TB size 208, an increase in the TB interval 210, no change in the TB interval 210, a decrease in the TB interval 210, a change in a communication channel, an increase in the delay margin 213, a decrease in the delay margin 213, or a combination thereof. To illustrate, the scheduler 110 may determine that the set of weights includes a TB size increase weight (e.g., the inadequate TB count 416) in response to determining that the updated schedule 107 indicates an increase in the TB size 208. The scheduler 110 may determine that the set of weights includes a TB size no change weight (e.g., 5) in response to determining that the updated schedule 107 indicates no change in the TB size 208. Alternatively, the scheduler 110 may determine that the set of weights includes a TB size decrease weight (e.g., 1) in response to determining that the updated schedule 107 indicates a decrease in the TB size 208. Similarly, the scheduler 110 may determine that the set of weights includes a delay margin increase weight (e.g., 2) in response to determining that the updated schedule 107 corresponds to an increase in the delay margin 213. Alternatively, the scheduler 110 may determine that the set of weights includes a delay margin decrease weight (e.g., 1) in response to determining that the updated schedule 107 corresponds to a decrease in the delay margin 213.

The scheduler 110 may determine that the set of weights includes a TB interval increase weight (e.g., 1) in response to determining that the updated schedule 107 indicates an increase in the TB interval 210. The scheduler 110 may determine that the set of weights includes a TB interval no change weight (e.g., 5) in response to determining that the updated schedule 107 indicates no change in the TB interval 210. Alternatively, the scheduler 110 may determine that the set of weights includes a TB interval decrease weight (e.g., 10) in response to determining that the updated schedule 107 indicates a decrease in the TB interval 210. The scheduler 110 may determine that the set of weights includes a communication channel change weight (e.g., 100) in response to determining that the updated schedule 107 indicates a change in a corresponding communication channel. For example, the copy of the schedule 107 may indicate the communication channel 113 and the updated schedule 107 may indicate the communication channel 413. The scheduler 110 may determine a value of the schdl_quality field 914 based on the sum of the set of weights. A higher value of the schdl_quality field 914 may indicate a higher quality (e.g., higher priority).

In a particular aspect, the heartbeat field 960 may indicate a longer duration than the schdl_start field 916. The second device 104 may continue to follow a previously advertised schedule (e.g., the copy of the schedule 107) until a start time indicated by the schdl_start field 916. The second device 104 may follow the updated schedule 107 subsequent to the start time. For example, a schedule window (e.g., the schedule window 462 of FIG. 4) corresponding to the updated schedule 107 may begin at the start time.

In a particular aspect, the data link group may include multiple provider devices (e.g., the first device 102 and a particular device). The first device 102 may refrain from transmitting the first schedule advertisement 115 indicating an updated schedule 107 in response to detecting a second schedule advertisement from the particular device that indicates an update to a schedule (e.g., the schedule 107) of the data link group. In a particular aspect, the first device 102 may refrain from updating the schedule 107 within a particular duration (e.g., 5 seconds) of a previous update to the schedule 107 of the data link group. For example, the first device 102 may continue to use the schedule 107 without updating until a next update period.

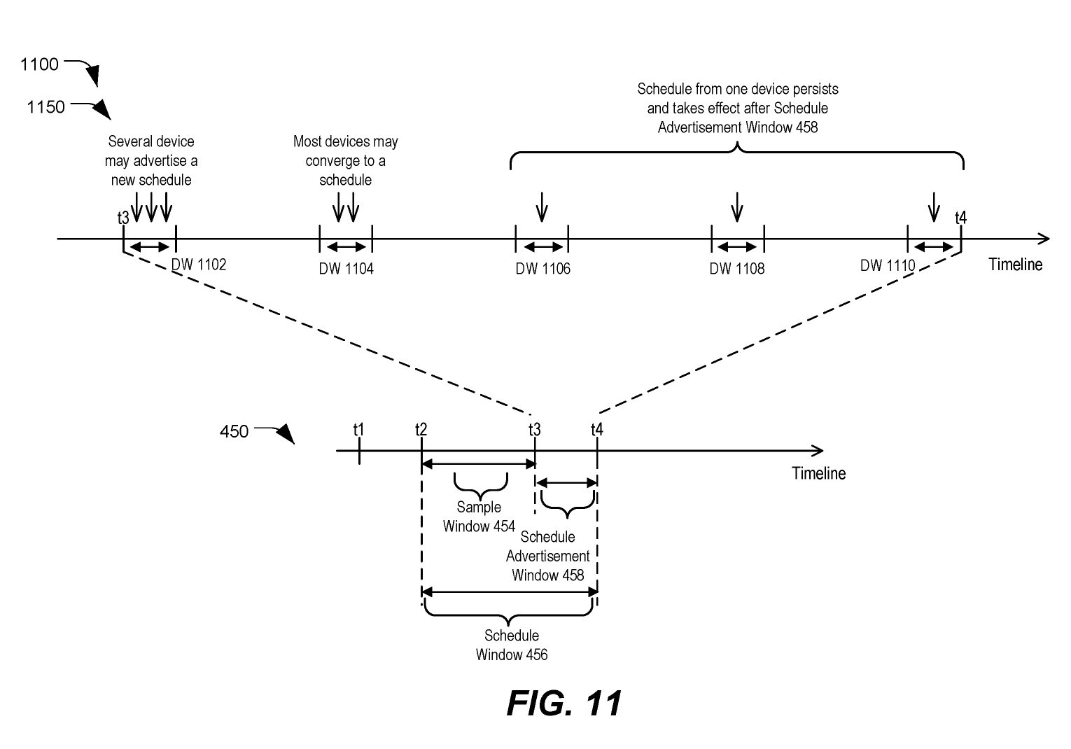

The second device 104 may receive schedule advertisements from multiple provider devices (e.g., the first device 102 and a particular device) of the data link group, as described with reference to FIG. 11. For example, the second device 104 may receive the first schedule advertisement 115 from the first device 102 and a second schedule advertisement from the particular device. The schdl_quality field 914 of the first schedule advertisement 115 may have a first value and the schdl_quality field 914 of the second schedule advertisement may have a second value. The second device 104 may disregard the schedule advertisement having the higher (or lower) value of the schdl_quality field 914. For example, the second device 104 may disregard the schedule advertisement indicating a lower schedule quality.

Referring to FIG. 10, a dynamic channel selection (DCS) attribute is shown and generally designated 1000. A NMF may include the DCS attribute 1000. The DCS attribute 1000 may indicate information related to channel scanning, channel reporting, or channel switching. The NMF may have a similar format as a SDF.

The DCS attribute 1000 may include an attribute ID field 1002, a length field 1004, a NDL MAC field 1006, a NDL group ID field 1008, a type field 1010, a DCS field 1012, or a combination thereof. The DCS field 1012 may include an element ID field 1052, a length field 1054, an operating class field 1056, a channel list field 1068, or a combination thereof.

During operation, the scheduler 110 of FIG. 1 may generate a NMF including the DCS attribute 1000. A particular value (e.g., 0x0F) of the attribute ID field 1002 may identify the corresponding attribute (e.g., the DCS attribute 1000) as a DCS attribute. The length field 1004 may indicate a length of the DCS attribute 1000. The NDL group ID field 1008 may indicate a data link identifier of the data link group.

The type field 1010 may indicate whether the DCS attribute 1000 corresponds to a channel scan request, a channel scan report, or channel switching information, as described herein. The scheduler 110 of FIG. 1 may determine that the schedule 107 is to be updated to have one or more of the time-blocks 109 correspond to another communication channel (e.g., the communication channel 413), as described with reference to FIG. 4. The scheduler 110 may determine that a set of channels is to be assessed. The set of channels may include preferred channels, may exclude non-preferred channels, or both. For example, a first channel that is likely to have traffic corresponding to other networks may not be included in the set of channels. The other networks may include a Bluetooth® network (Bluetooth is a registered trademark of Bluetooth SIG, Inc. of Kirkland, Wash.), a Long-Term Evolution (LTE®) network (LTE is a registered trademark of Institut Européen des Normes of France), a LTE-U network, or another network.

In a particular aspect, a particular device may, at various times (e.g., periodically), scan one or more channels to generate channel load information corresponding to the one or more channels. The particular device may determine a list of access points (APs) operating on each of the one or more channels. The particular device may include the first device 102, the second device 104, or both. For example, the scheduler 110 may generate a first list of channels and corresponding APs, and the second device 104 may generate a second list of channels and corresponding APs. The second device 104 may send the second list to the first device 102.

The scheduler 110 may determine the set of channels based on the first list, the second list, or both. For example, the scheduler 110 may select a first channel with no corresponding AP. The scheduler 110 may select one or more channels having a lower number of corresponding APs. The scheduler 110 may select one or more channels where a traffic advertisement (e.g., a traffic indication map (TIM)) of the corresponding AP indicates a fewer number of data recipients. Fewer number of data recipients may be indicative of lower downlink traffic.

In a particular aspect, the first device 102, the second device 104, or both, may be associated with a particular AP. The scheduler 110 may determine that the set of channels includes an AP communication channel corresponding to the particular AP, an infrastructure channel of the NAN (e.g., the NAN channel), or a channel based on the first list, the second list, or both. For example, the scheduler 110 may determine that the set of channels includes the AP communication channel in response to determining that a medium occupancy of the AP communication channel satisfies (e.g., is below) an AP threshold. The scheduler 110 may determine the medium occupancy based on detected latency of uplink traffic, a number of bits of a TIM of a beacon element having a first value (e.g., 1), request to send (RTS)/clear to send (CTS) transmission opportunity (TxOP) reservations, or a combination thereof.

The scheduler 110 may determine that the set of channels includes the infrastructure channel in response to determining that an occupancy of the infrastructure channel satisfies (e.g., is less than or equal to) an infrastructure threshold. The scheduler 110 may, in response to determining that the medium occupancy of the AP communication channel fails to satisfy the AP threshold and that the occupancy of the infrastructure channel fails to satisfy the infrastructure threshold, determine the set of channels based on the first list, the second list, or both.

The scheduler 110 may, in response to determining that a count of the set of channels satisfies a channel count threshold, determine that the first device 102 is to assess the set of channels. Alternatively, the scheduler 110 may, in response to determining that the count fails to satisfy the channel count threshold, determine that other devices (e.g., the second device 104) of the data link group are to assess a subset of the channels. For example, the scheduler 110 may determine that the first device 102 is to assess a first subset of channels, the second device 104 is to assess a second subset of channels, a third device is to assess a third subset of channels, or a combination thereof.

The scheduler 110 may, in response to determining that the second device 104 is to assess the second subset of channels, generate a first NMF including the DCS attribute 1000. The NDL MAC field 1006 may indicate an identifier (e.g., a MAC address) of the first device 102. The type field 1010 of the DCS attribute 1000 of the first NMF may have a first value (e.g., 1) that corresponds to a channel scan request. When the type field 1010 has the first value, the DCS field 1012 may correspond to an access point (AP) channel report element format. The length field 1054 may indicate a length of the DCS field 1012. The channel list field 1068 may indicate the second subset of channels.

The scheduler 110 may transmit the first NMF via the transmitter 112 of FIG. 1 to the second device 104 during a paging window of a time-block (e.g., the first TB 111). For example, the transmitter 112 may transmit the first NMF as a unicast message to the second device 104 during the paging window. The second device 104 may, in response to receiving the first NMF, send an ACK to the first device 102. The first device 102 may, in response to determining that no ACK responsive to the first NMF is received from the second device 104 during a particular duration of sending the first NMF, retransmit the first NMF to the second device 104. The particular duration may include a SIFS (short interframe space) interval.

The second device 104 may, in response to receiving the first NMF from the first device 102, scan the second subset of channels indicated in the first NMF. In a particular aspect, the second device 104 may scan the second subset of channels subsequent to the first TB 111 or subsequent to transitioning to the second operating mode during a portion of the first TB 111. The second device 104 may scan a particular channel of the second subset of channels by switching to the particular channel. The second device 104 may determine a particular channel load corresponding to the particular channel. The particular channel load may correspond to unusable channel time, level of occupancy (α), level of concurrent operations (β), or a combination thereof. The second device 104 may determine channel loads corresponding to the second subset of channels. The second device 104 may determine a second channel corresponding to a second channel load (e.g., a lowest channel load) of the channel loads.

The second device 104 may generate a second NMF including the DCS attribute 1000. The DCS field 1012 of the second NMF may indicate the second channel and the second channel load. For example, a first portion (e.g., a first octet) of the DCS field 1012 may indicate the second channel, and a second portion (e.g., a second octet) of the DCS field 1012 may indicate the second channel load. The NDL MAC field 1006 may indicate an identifier (e.g., a MAC address) of the second device 104. The type field 1010 of the DCS attribute 1000 of the second NMF may have a second value (e.g., 2) that corresponds to a channel scan report. The second device 104 may transmit the second NMF as a unicast message to the first device 102. The second device 104 may transmit the second NMF during a paging window of a particular time-block (e.g., the second TB 211). The particular time-block may be subsequent to a time-block during which the first NMF is received by the second device 104.

The first device 102 may, in response to receiving the second NMF, send an ACK to the second device 104. The second device 104 may, in response to determining that no ACK responsive to the second NMF is received from the first device 102 during a particular duration of sending the second NMF, retransmit the second NMF to the first device 102. The particular duration may include a SIFS (short interframe space) interval.

The scheduler 110 may similarly scan the first subset of channels and may identify a first channel corresponding to a first channel load. The scheduler 110 may transmit a particular first NMF to the third device. The first device 102 may receive a particular second NMF from the third device indicating a third channel of the third subset of channels and a corresponding third channel load.

The scheduler 110 may select a particular channel of multiple channels based on corresponding channel loads. The multiple channels may include the first channel, the second channel, the third channel, or a combination thereof. For example, the scheduler 110 may select the particular channel corresponding to a particular channel load (e.g., a lowest channel load) of the first channel load, the second channel load, the third channel load, or a combination thereof.

The scheduler 110 may generate a third NMF including the DCS attribute 1000. The DCS field 1012 of the third NMF may indicate the particular channel (e.g., the communication channel 413 of FIG. 4) and a start time at which the particular channel goes into effect. For example, a first portion (e.g., a first octet) of the DCS field 1012 may indicate the particular channel, and a second portion (e.g., a second octet) of the DCS field 1012 may indicate the start time. The start time may correspond to a number (e.g., 5) of discovery windows (or discovery window intervals). The NDL MAC field 1006 may indicate an identifier (e.g., a MAC address) of the first device 102. The type field 1010 of the DCS attribute 1000 of the third NMF may have a third value (e.g., 3) that corresponds to channel switch information. The first device 102 may transmit the third NMF as a unicast message each device (e.g., the second device 104) of the data link group. The first device 102 may transmit the third NMF during a paging window of a particular time-block (e.g., the second TB 211).

The second device 104 may, in response to receiving the third NMF, send an ACK to the first device 102. The first device 102 may, in response to determining that no ACK responsive to the third NMF is received from the second device 104 during a particular duration of sending the third NMF, retransmit the third NMF to the second device 104. The particular duration may include a SIFS (short interframe space) interval.

The scheduler 110 may update the schedule 107 such that one or more of the time-blocks 109 correspond to the particular channel (e.g., the communication channel 413) indicated by the third NMF. The scheduler 110 may generate the first schedule advertisement 115 indicating the updated schedule 107, as described with reference to FIG. 4. The first schedule advertisement 115 may indicate the start time indicated by the third NMF. The scheduler 110 may transmit the scheduler advertisement 115. The first device 102, the second device 104, or both, may communicate via the particular channel during the one or more of the time-blocks 109 subsequent to the start time.

Referring to FIG. 11, a diagram of timelines is shown and generally designated 1100. The diagram 1100 includes a timeline 1150. The timeline 1150 may correspond to a portion of the timeline 450 of FIG. 4.

The first device 102 may correspond to one of multiple provider devices of the data path link. A first schedule (e.g., the schedule 107) may be valid (e.g., in effect) during the schedule window 456. Each of a plurality of provider devices of the data path link may generate a corresponding schedule based on performance data determined (or updated) during the sample window 454. For example, the scheduler 110 of the first device 102 may generate a second schedule (e.g., the schedule 107) based on the performance data 401, as described with reference to FIG. 4. Each of the plurality of provider devices may advertise the corresponding schedule during the schedule advertisement window 458. For example, the first device 102 may transmit the first schedule advertisement 115 indicating the second schedule (e.g., the schedule 107) during the schedule advertisement window 458.

The plurality of provider devices may converge on a single schedule over the schedule advertisement window 458. For example, the schedule advertisement window 458 may include a DW 1102, a DW 1104, a DW 1106, a DW 1108, a DW 1110, or a combination thereof. In a particular aspect, a value of the schdl_start field 916 of the first schedule advertisement 115 may indicate a number of discovery windows included in the schedule advertisement window 458. The plurality of provider devices may advertise the corresponding schedule during the DW 1102. For example, the first device 102 may, during the DW 1102, transmit the first schedule advertisement 115 indicating the second schedule (e.g., the schedule 107). A second provider device may transmit a first schedule advertisement indicating a first particular schedule. The provider devices may, during the DW 1102, receive schedule advertisements from one or more other provider devices. For example, the first device 102 may receive, via the receiver 114 of FIG. 1, the second schedule advertisement from the second provider device.

A subset (e.g., some, most, or all) of the provider devices may converge on a single schedule based on the received schedule advertisements. For example, the first device 102 may, subsequent to the DW 1102, select the second schedule from the second schedule and the schedules received by the first device 102 during the DW 1102, as described herein. Similarly, the second provider device may, subsequent to the DW 1102, select the second schedule from the first particular schedule and the schedules received by the second provider device during the DW 1102. During the DW 1104, one or more of the subset of the provider devices may advertise the single schedule. For example, the first device 102, the second provider device, or both, may advertise the second schedule (e.g., the schedule 107) during the DW 1104. To illustrate, during the DW 1104, the first device 102 may transmit the first schedule advertisement 115 indicating the second schedule, the second provider device may transmit a second particular schedule advertisement indicating the second schedule, or both.

In a particular aspect, the subset of the provider devices may include all of the provider devices. In an alternate aspect, the subset of the provider devices may include fewer than all of the provider devices and a remaining subset of the provider devices may converge on the single schedule during a subsequent DW. For example, the remaining subset of the provider devices may converge on the second schedule (e.g., the schedule 107) during the DW 1106. Subsequent to converging, one or more of the provider devices may advertise the second schedule (e.g., the schedule 107) during a remaining portion of the schedule advertisement window 458. For example, one or more of the provider devices may advertise the second schedule (e.g., the schedule 107) during the DW 1108, the DW 1110, or both. The second schedule (e.g., the schedule 107) may be valid (e.g., in effect) subsequent to the schedule advertisement window 458. For example, the second schedule (e.g., the schedule 107) may be valid during the schedule window 462 of FIG. 4.

In a particular aspect, the first device 102 may receive a second schedule advertisement indicating a second particular schedule from a second provider device. The scheduler 110 may select one of the schedule 107 and the second particular schedule, as described herein. The scheduler 110 may perform the selection based on a first schedule corresponding to the schedule 107 and a second schedule metric corresponding to the second particular schedule. The first schedule metric may correspond to a value of the schdl_quality field 914. The scheduler 110 may determine the value of the schdl_quality field 914, as described with reference to FIG. 9. The scheduler 110 may determine that the second schedule advertisement (e.g., the schdl_quality field 914) indicates the second schedule metric.

In an alternate aspect, the scheduler 110 may determine the first schedule metric corresponding to the schedule 107 based on TB metrics of the TBs 109, as described with reference to FIG. 3. The scheduler 110 may determine the second schedule metric corresponding to the second particular schedule based on TB metrics of corresponding TBs, as described with reference to FIG. 3.

The scheduler 110 may select the schedule 107 in response to determining that the first schedule metric is greater than the second schedule metric. In an alternate aspect, the scheduler 110 may select the schedule 107 in response to determining that the first schedule metric is lower than the second schedule metric.

The scheduler 110 may, in response to determining that the first schedule metric is the same as the second schedule metric, perform the selection based on a first identifier (e.g., a MAC address) corresponding to the schedule 107 and a second identifier (e.g., a MAC address) corresponding to the second particular schedule. For example, the scheduler 110 may select the schedule 107 in response to determining that the first identifier is greater than the second identifier. In an alternate aspect, the scheduler 110 may select the schedule 107 in response to determining that the first identifier is less than or equal to the second identifier. The first identifier may include an identifier (e.g., a MAC address) of the first device 102 and the second identifier may include an identifier (e.g., a MAC address) of the second provider device.

A particular service may be provided by multiple provider devices. The provider devices may converge on a single schedule that satisfies the target QoS 101 corresponding to the particular service.

Referring to FIG. 12, a method of operation is shown and generally designated 1200. The method 1200 may be performed by the first device 102 of FIG. 1.

The method 1200 includes determining, at a particular device, a target quality of service (QoS), at 1202. For example, the scheduler 110 of FIG. 1 may determine, at the first device 102, the target QoS 101, as described with reference to FIG. 1.

The method 1200 also includes determining, based on the target QoS, a schedule identifying one or more transmission time-blocks, at 1204. For example, the scheduler 110 of FIG. 1 may determine, at the first device 102, the schedule 107 based on the target QoS 101, as described with reference to FIG. 1. The schedule 107 may indicate the one or more time-blocks 109.

The method 1200 further includes sending data, from the particular device to at least one device, during a transmission time-block of the one or more transmission time-blocks, at 1206. For example, the scheduler 110 may send the data 117, from the first device 102 to the second device 104, during the first TB 111 of the time-blocks 109, as described with reference to FIG. 2.

The method 1200 may thus enable generating the schedule 107 based on the target QoS 101. Devices may exchange data based on the schedule 107.

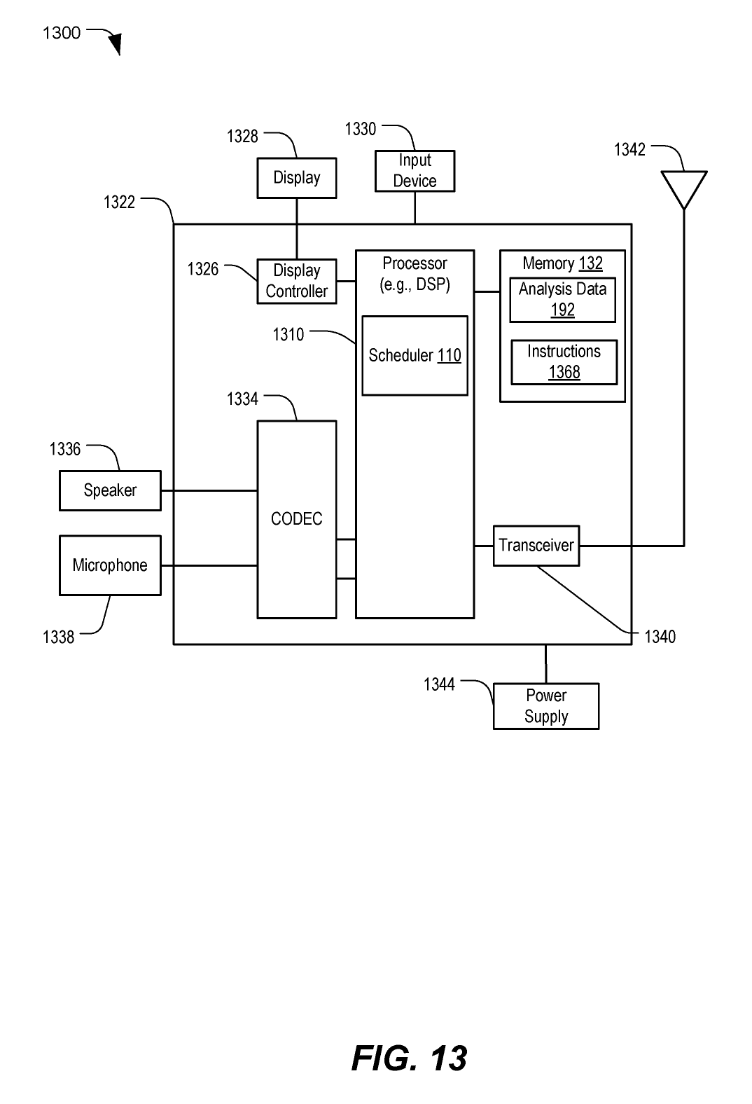

Referring to FIG. 13, a block diagram of a device (e.g., a wireless communication device) is depicted and generally designated 1300. In various implementations, the device 1300 may have fewer or more components than illustrated in FIG. 13. In an illustrative implementation, the device 1300 may correspond to the first device 102, the second device 104 of FIG. 1, or both. In an illustrative aspect, the device 1300 may operate according to one or more methods or systems described with reference to FIGS. 1-12.

In a particular aspect, the device 1300 includes a processor 1310 (e.g., a central processing unit (CPU), a digital signal processor (DSP), or both). The processor 1310 may include the scheduler 110. The device 1300 may include the memory 132 and a CODEC 1334. The device 1300 may include a transceiver 1340 coupled to an antenna 1342. The transceiver 1340 may include the transmitter 112, the receiver 114 of FIG. 1, or both. The device 1300 may include the display 1328 coupled to a display controller 1326. A speaker 1336, a microphone 1338, or both, may be coupled to the CODEC 1334.

The memory 132 may include instructions 1368 executable by the processor 1310, the CODEC 1334, one or more other processing units of the device 1300, or a combination thereof, to perform methods and processes disclosed herein, such as the method 1200 of FIG. 12. The memory 132 may include the analysis data 192.

One or more components of the system 100 may be implemented via dedicated hardware (e.g., circuitry), by a processor executing instructions to perform one or more tasks, or a combination thereof. As an example, the memory 132 may be a memory device, such as a random access memory (RAM), magnetoresistive random access memory (MRAM), spin-torque transfer MRAM (STT-MRAM), flash memory, read-only memory (ROM), programmable read-only memory (PROM), erasable programmable read-only memory (EPROM), electrically erasable programmable read-only memory (EEPROM), registers, hard disk, a removable disk, or a compact disc read-only memory (CD-ROM). The memory device may include instructions (e.g., the instructions 1368) that, when executed by a computer (e.g., a processor in the CODEC 1334 and/or the processor 1310), may cause the computer to perform at least a portion of one of the methods described herein. As an example, the memory 132 may be a non-transitory computer-readable medium that includes instructions (e.g., the instructions 1368) that, when executed by a computer (e.g., a processor in the CODEC 1334 and/or the processor 1310), cause the computer perform at least a portion of the methods described herein.

In a particular aspect, the device 1300 may be included in a system-in-package or system-on-chip device (e.g., a mobile station modem (MSM)) 1322. In a particular aspect, the processor 1310, the display controller 1326, the memory 132, the CODEC 1334, and the transceiver 1340 are included in a system-in-package or the system-on-chip device 1322. In a particular aspect, an input device 1330, such as a touchscreen and/or keypad, and a power supply 1344 are coupled to the system-on-chip device 1322. Moreover, in a particular aspect, as illustrated in FIG. 13, the display 1328, the input device 1330, the speaker 1336, the microphone 1338, the antenna 1342, and the power supply 1344 are external to the system-on-chip device 1322. However, each of the display 1328, the input device 1330, the speaker 1336, the microphone 1338, the antenna 1342, and the power supply 1344 can be coupled to a component of the system-on-chip device 1322, such as an interface or a controller. The device 1300 may include a mobile phone, a communication device, a computer, a music player, a video player, an entertainment unit, a navigation device, a personal digital assistant (PDA), a decoder, a set top box, or any combination thereof.

In an illustrative aspect, the processor 1310 may be operable to perform all or a portion of the methods or operations described with reference to FIGS. 1-12. For example, the processor 1310 may determine the target QoS 101, as described with reference to FIG. 1. The processor 1310 may determine the schedule 107 based on the target QoS 101. The schedule 107 may indicate the time-blocks 109. The processor 1310 may send the data 117 via the transceiver 1340 during the first TB 111 of the time-blocks 109, as described with reference to FIG. 1.

In conjunction with described aspects, an apparatus includes means for determining a transmission schedule identifying one or more transmission time-blocks. For example, the means for determining may include the scheduler 110, the first device 102 of FIG. 1, the processor 1310, the device 1300, one or more circuits or devices configured to determine a transmission schedule identifying one or more transmission time-blocks (e.g., a processor executing instructions at a non-transitory computer readable storage medium), or a combination thereof. The transmission schedule (e.g., the schedule 107) may be based on the target QoS 101.

The apparatus also includes means for transmitting data to at least one device during a transmission time-block of the one or more transmission time-blocks based on the transmission schedule. For example, the means for transmitting data may include the transmitter 112, the first device 102 of FIG. 1, the transceiver 1340, the device 1300, one or more circuits or devices configured to transmit data, or a combination thereof.

The previous description of the disclosed aspects is provided to enable a person skilled in the art to make or use the disclosed aspects. Various modifications to these aspects will be readily apparent to those skilled in the art, and the principles defined herein may be applied to other aspects without departing from the scope of the disclosure. Thus, the present disclosure is not intended to be limited to the aspects shown herein but is to be accorded the widest scope possible consistent with the principles and novel features as defined by the following claims.

What is claimed is:

1. A device for communication comprising:
a processor configured to:
determine a target quality of service (QoS); and
determine, based on the target QoS, a transmission schedule identifying one or more transmission time-blocks; and
a transmitter configured to transmit data to at least one device during a transmission time-block of the one or more transmission time-blocks.

2. The device of claim 1, wherein the transmission schedule indicates a size of the transmission time-block, a communication channel corresponding to the transmission time-block, a discovery window offset of the transmission time-block, a time interval between consecutive transmission time-blocks, or a combination thereof.

3. The device of claim 1, wherein the target QoS includes at least one of a target latency corresponding to a service and a target data rate corresponding to the service.

4. The device of claim 1, wherein the processor is further configured to determine a time interval between consecutive transmission time-blocks of the transmission schedule based on a delay margin and a target latency of the target QoS.

5. The device of claim 1, wherein the processor is further configured to determine a size of the transmission time-block based on a target data rate of the target QoS, an estimated transmission bit rate limit, an overhead factor, and a time interval between consecutive transmission time-blocks of the transmission schedule.

6. The device of claim 1, wherein the processor is further configured to determine a level of occupancy of the transmission time-block based on one or more second schedules identifying at least a portion of the transmission time-block, wherein a time-block metric of the transmission time-block indicates the level of occupancy of the transmission time-block.

7. The device of claim 1, wherein a time-block metric of the transmission time-block indicates a level of concurrent operations of the transmission time-block.

8. The device of claim 1, further comprising a receiver configured to receive a schedule advertisement from a second device, the schedule advertisement indicating a second transmission schedule, wherein the processor is further configured to, prior to transmission of the data, select the transmission schedule from the transmission schedule and the second transmission schedule based on a first schedule metric and a second schedule metric, wherein the first schedule metric is associated with the transmission schedule and the second schedule metric is associated with the second transmission schedule.

9. The device of claim 8, wherein the schedule advertisement indicates the second schedule metric.

10. The device of claim 8, wherein the schedule advertisement is received during a schedule advertisement window, wherein the processor is further configured to generate a first schedule advertisement indicating the transmission schedule, and wherein the transmitter is further configured to transmit the first schedule advertisement during the schedule advertisement window.

11. The device of claim 10, wherein the transmission schedule is valid during a schedule window subsequent to the schedule advertisement window, and wherein the data is transmitted during the schedule window.

12. The device of claim 1, further comprising a memory buffer configured to queue packets prior to transmission by the transmitter, wherein the processor is further configured to:
determine a count of packets in the memory buffer at an end of each of a plurality of transmission time-blocks; and
selectively update the transmission schedule based on the count of packets.

13. The device of claim 12, wherein the processor is further configured to, in response to determining that the count of packets is zero, update the transmission schedule to decrease a size of the one or more transmission time-blocks.

14. A method of communication comprising:
determining, at a particular device, a target quality of service (QoS);
determining, based on the target QoS, a transmission schedule identifying one or more transmission time-blocks; and
sending data, from the particular device to at least one device, during a transmission time-block of the one or more transmission time-blocks.

15. The method of claim 14, further comprising, prior to transmitting the data:
receiving a schedule negotiation message from a first device of the at least one device, the schedule negotiation message indicating a set of proposed schedules;
determining that a subset of proposed transmission schedules of the set satisfy the target QoS; and
determining the transmission schedule based on the subset of proposed transmission schedules.

16. The method of claim 15, further comprising:
determining schedule metrics corresponding to each of the subset of proposed transmission schedules; and
selecting the transmission schedule from the subset of proposed transmission schedules based on the schedule metrics.

17. The method of claim 15, further comprising:
determining schedule metrics corresponding to each of the subset of proposed transmission schedules;
determining that each of the schedule metrics fails to satisfy a metric threshold; and
determining the transmission schedule based on the target QoS and on availability indicated by the schedule negotiation message.

18. A computer-readable storage device storing instructions that, when executed by a processor, cause the processor to perform operations comprising:
determining a target quality of service (QoS);
determining, based on the target QoS, a transmission schedule identifying one or more transmission time-blocks; and
sending data to at least one device during a transmission time-block of the one or more transmission time-blocks.

19. The computer-readable storage device of claim 18, wherein the transmission time-block is associated with a communication channel, wherein a second transmission time-block of the one or more transmission time-blocks is associated with a second communication channel that is distinct from the communication channel.

20. The computer-readable storage device of claim 19, wherein the communication channel corresponds to one of a 2.4 gigahertz (GHz) wireless communication channel, a 3.65 GHz wireless communication channel, a 4.9 GHz wireless communication channel, a 5 GHz wireless communication channel, a 5.9 GHz wireless communication channel, a 60 GHz wireless communication channel, or a 900 megahertz (MHz) wireless communication channel, and the second communication channel corresponds to another of the 2.4 GHz wireless communication channel, the 3.65 GHz wireless communication channel, the 4.9 GHz wireless communication channel, the 5 GHz wireless communication channel, the 5.9 GHz wireless communication channel, the 60 GHz wireless communication channel, or the 900 megahertz MHz wireless communication channel.

21. The computer-readable storage device of claim 18, wherein the data is sent via a communication channel corresponding to the transmission time-block, wherein the operations further comprise sending second data, via a second communication channel, to the at least one device during a second transmission time-block of the one or more transmission time-blocks based on the transmission schedule, wherein the second transmission time-block corresponds to the second communication channel, and wherein the second communication channel is distinct from the communication channel.

22. The computer-readable storage device of claim 18, wherein the operations further comprise determining a second target QoS,
wherein the target QoS corresponds to a first service and the second target QoS corresponds to a second service, and
wherein the transmission schedule is based on the target QoS and the second target QoS.

23. The computer-readable storage device of claim 22, wherein the operations further comprise:
determining a first transmission schedule based on the target QoS; and
determining a second transmission schedule based on the second target QoS,
wherein the transmission schedule is based on aggregating the first transmission schedule and the second transmission schedule.

24. The computer-readable storage device of claim 22, wherein the operations further comprise:
determining a first transmission schedule based on the target QoS;
determining a second transmission schedule based on the second target QoS;
determining that a first transmission time-block of the first transmission schedule has a first size and that a second transmission time-block of the second transmission schedule has a second size; and
in response to determining that the first transmission time-block overlaps a second transmission time-block, generating a particular transmission time-block of the transmission schedule having a particular size corresponding to a sum of the first size and the second size.

25. The computer-readable storage device of claim 18, wherein the operations further comprise, in response to determining that no target QoS is associated with a service:
determining the target QoS based on a default value, wherein the transmission schedule is associated with the service;
updating the transmission schedule; and
storing the updated transmission schedule in a memory.

26. The computer-readable storage device of claim 18, wherein the operations further comprise, in response to a subsequent activation of the service:
determining that no target QoS is associated with the service;
determining that the transmission schedule associated with the service is stored in a memory; and
sending a packet corresponding to the service based on the transmission schedule.

27. The computer-readable storage device of claim 18, wherein the operations further comprise, in response to determining that no target QoS is associated with a service, determining a profile associated with the service, wherein the target QoS is based on the profile.

28. The computer-readable storage device of claim 27, wherein the profile includes a gaming profile, a music profile, a voice over internet protocol (VOIP) profile, or a combination thereof.

29. An apparatus comprising:
means for determining a transmission schedule identifying one or more transmission time-blocks, the transmission schedule based on a target quality of service (QoS); and
means for transmitting data to at least one device during a transmission time-block of the one or more transmission time-blocks.

30. The apparatus of claim 29, wherein the means for determining and the means for transmitting are integrated into at least one of a communication device, a navigation device, a computer, a music player, a video player, an entertainment unit, a personal digital assistant (PDA), and a set top box.
